(19) United States
(12) Patent Application Publication
(10) Pub. No.: US 2026/0106155 A1
(43) Pub. Date: Apr. 16, 2026

(54) DRY FRIABLE FLUOROPOLYMER AGGLOMERATE COMPOSITIONS FOR USE AS BINDER IN LITHIUM-ION SECONDARY BATTERY ELECTRODES

(71) Applicant: THE CHEMOURS COMPANY FC, LLC, WILMINGTON, DE (US)

(72) Inventors: SHANKAR ARYAL, MIDDLETOWN, DE (US); CARA BLANKENBICKER, WASHINGTON, WV (US); DENNIS J. KOUNTZ, WEST CHESTER, PA (US); ADAM PAUL SMITH, PARKERSBURG, WV (US); TEJAS UPASANI, WILMINGTON, DE (US); CRYSTAL K. WATERS, WILSON, NC (US); SHIDI XUN, HOCKESSIN, DE (US); KOSTANTINOS KOURTAKIS, MEDIA, PA (US)

(73) Assignee: THE CHEMOURS COMPANY FC, LLC, WILMINGTON, DE (US)

(21) Appl. No.: 19/116,544

(22) PCT Filed: Sep. 27, 2023
(86) PCT No.: PCT/US2023/033819

§ 371 Date: Mar. 28, 2025

Related U.S. Application Data
(60) Provisional application No. 63/441,777, filed on Jan. 28, 2023.

(51) Int. Cl. H01M 4/62; H01M 4/02; H01M 4/485; H01M 10/0525

(52) U.S. Cl. CPC H01M 4/623; H01M 4/485; H01M 4/625; H01M 10/0525; H01M 2004/028

(57) ABSTRACT

Fluoropolymer compositions for use as binder in a lithium-ion secondary battery electrodes are described, as well as methods of their manufacture, and electrode compositions and lithium-ion secondary batteries utilizing such. The fluoropolymer compositions are dry friable agglomerates manufactured by cocoagulation of aqueous dispersions of a first tetrafluoroethylene polymer having a melt creep viscosity of at least about 0.5×1011 poise, and a second polymer different from the first polymer. These fluoropolymer compositions afford lithium-ion secondary batteries with improved performance, through such as improved loading of electrodes, and stability of PTFE binder in the anode, and result in lithium-ion secondary batteries having improved performance, such as improved capacity and improved reversible capacity retention.

### CROSS REFERENCE TO RELATED APPLICATIONS

This application claims the priority benefit of U.S. provisional patent application No. 63/411,777, filed on Sep. 30, 2022, the disclosure of which is hereby incorporated by reference in its entirety.

### FIELD

The present disclosure relates to dry friable fluoropolymer agglomerate compositions for use as binder in lithium-ion secondary battery electrodes, methods for the dry manufacture of such compositions, electrode compositions and electrodes, and lithium-ion batteries utilizing such electrodes.

### BACKGROUND

Tremendous industry efforts have been dedicated to exploring lithium-ion secondary battery electrode compositions and viable electrode fabrication processes, for the purpose of improving battery performance. Many methods however, have either complex fabrication procedures or are limited to lab scale processing, and many current commercial electrode compositions suffer from relatively poor performance for real-world wide-scale adoption and utility. Many existing lithium-ion battery electrode manufacturing methods involve slurry technology utilizing NMP (N-Methylpyrrolidone) as a solvent, which is toxic and requires expensive solvent recycling equipment, making the slurry-based fabrication process costly and undesirable.

Unlike the above-mentioned methods based on solvents such as NMP, fabrication using binder fibrillation is a dry process, where high molecular weight and fibrilatable polytetrafluoroethylene (PTFE) is a known utilized binder. In this process, PTFE particles are shear mixed and under these conditions form adhesive fibrils which can bind electrode active materials even at relatively low binder content, and such dry electrodes have been drawing increased industrial interest. Compared to the solvent slurry-based method, this dry process has the potential to fabricate roll-to-roll electrode with unlimited thickness and minimal cracks. More importantly, the removal of toxic NMP and solvent recycling equipment makes the dry process a cost-effective and environmentally benign electrode manufacturing strategy.

Wide-scale adoption and commercial utility of PTFE-based lithium-ion secondary battery electrode binders has been hampered by certain shortcomings of PTFE. Among others, such shortcomings include the difficulty of formulating PTFE in electrode compositions at appropriate PTFE particle size to substantially match that of electrode actives without the PTFE prematurely fibrilating and forming non-homogeneous and poor particle size distribution electrode compositions, as well as the relative instability (versus the incumbent slurry-based commercial binder PVDF) of PTFE towards reduction under lithium-ion battery anode operating conditions.

The present invention addresses certain shortcomings of prior work in this field by offering dry friable fluoropolymer agglomerate compositions of utility for electrode binder, electrode binder compositions, methods of their manufacture, and lithium-ion secondary batteries utilizing such, based on cocoagulated tetrafluoroethylene polymer and a second polymer compositions. The present compositions afford lithium-ion secondary batteries with improved performance over the prior art. For example, the present binder compositions have the potential to positively effect loading of electrodes, stability of PTFE binder in electrodes (especially the anode), and resulting in lithium-ion secondary batteries having improved capacity and improved reversible capacity retention.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The present invention addresses shortcomings of prior work in this field by offering, in one embodiment, fluoropolymer compositions for use as binder in a lithium-ion secondary battery electrode, comprising dry friable agglomerates comprising: i.) a first polymer comprising a tetrafluoroethylene polymer having a melt creep viscosity of at least about 0.5×10¹¹ poise, and; ii.) a second polymer different from the first polymer.

In another embodiment, provided is a method for manufacturing an electrode composition for use in a lithium-ion secondary battery electrode, comprising: IV.) milling electrode active particles together with dry friable agglomerates to form the electrode composition comprising fibrillated tetrafluoroethylene polymer, wherein the dry friable agglomerates comprise: i.) a first polymer comprising unfibrillated tetrafluoroethylene polymer having a melt creep viscosity of at least about 0.5×10¹¹ poise, and; ii.) a second polymer different from the first polymer. Also included is the method, wherein prior to the aforementioned milling step, carrying out the steps: I.) cocoagulating: I.-i) an aqueous dispersion of first polymer comprising unfibrillated tetrafluoroethylene polymer having a melt creep viscosity of at least about 0.5×10¹¹ poise; and I.-ii) a second polymer different from the first polymer, to produce friable agglomerates of the first and second polymers; II.) separating the friable agglomerates from said aqueous phase; III.) drying the friable agglomerates; and thereby forming dry friable agglomerates comprising particles of the first polymer and the second polymer.

In another embodiment, provided is a composition for use in a lithium-ion secondary battery cathode film, comprising: i.) cathode active particles comprising lithium transition metal oxide; ii.) conductive carbon; and iii.) fluoropolymer binder comprising a mixture of particles of tetrafluoroethylene polymer having a melt creep viscosity of at least about 0.5×10¹¹ poise, and a second polymer; the said tetrafluoroethylene polymer is fibrillated.

In another embodiment, provided is a composition for use in a lithium-ion secondary battery anode film, comprising: i.) anode active particles; and iii.) fluoropolymer binder comprising a mixture of particles of tetrafluoroethylene polymer having a melt creep viscosity of at least about 0.5×10¹¹ poise, and a second polymer; wherein the tetrafluoroethylene polymer is fibrillated.

In another embodiment, provided is a lithium-ion secondary battery comprising: 1) a cathode comprising: a cathode electrode layer adhered to a metal current collector, the cathode electrode layer comprising a cathode electrode composition comprising: a) cathode active particles comprising lithium transition metal oxide; b) conductive carbon; and c) fluoropolymer binder comprising a mixture of: i) particles of tetrafluoroethylene polymer having a melt creep viscosity of at least about 0.5×10¹¹ poise; and ii) particles of a second polymer; 2) an anode; 3) a separator between said cathode and said anode; and 4) an electrolyte in communication with said cathode, anode and separator.

In another embodiment, provided is a lithium-ion secondary battery comprising: 1) an anode comprising: an anode electrode layer adhered to a metal current collector, said anode electrode layer comprising an anode electrode composition comprising: a) anode active particles; and b) fluoropolymer binder comprising a mixture of: i) particles of tetrafluoroethylene polymer having melt creep viscosity of at least about 0.5×10¹¹ poise; and ii) particles of second polymer; 2) a cathode; 3) a separator between said cathode and said anode; and 4) an electrolyte in communication with said cathode, anode and separator.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

### BRIEF DESCRIPTION OF THE DRAWINGS

FIGS. 1-6 are plots of particle diameter (D-50 (microns)) versus pressure (psi) obtained using a particle size analyzer to examine friability of agglomerates of present dry friable fluoropolymer compositions and comparative compositions.

FIGS. 7-9 are plots of cycling performance (discharge specific capacity (mAh/g) versus cycle number at various C rates of half cell batteries using present inventive dry method prepared cathodes, compared to similar comparative half cell batteries.

FIGS. 10-11 are plots of cyclic voltammetry measurements (Current (mA) versus Potential versus Li (V)) carried out on anodes prepared using present dry friable fluoropolymer compositions and comparative compositions.

FIG. 12 is an interval plot showing 1^{st} coulombic efficiency (%) for half cell batteries using present inventive dry method prepared anodes prepared using a present dry friable fluoropolymer composition and a comparative composition.

FIG. 13 is a plot of cycling performance (delithiation capacity (mAh/g)) versus cycle number at various C rates of half cell batteries using present inventive dry method prepared anodes, compared to similar comparative half cell batteries.

FIGS. 14-17 are plan view images of the surface of present inventive dry method prepared anodes by SEM at various magnification.

### DETAILED DESCRIPTION

### Binder Composition

The present invention includes a fluoropolymer composition for use as binder in a lithium-ion secondary battery electrode, comprising dry friable agglomerates of: i.) a first polymer comprising a tetrafluoroethylene polymer having a melt creep viscosity of at least about 0.5×10¹¹ poise, and; ii.) a second polymer different from the first polymer.

In one embodiment the agglomerates comprise particles of the first polymer and particles of the second polymer. In another embodiment the agglomerates comprise particles of the first polymer having at least a partial coating comprising the second polymer.

### First Polymer-Tetrafluoroethylene Polymer

The present fluoropolymer composition includes a first polymer comprising a tetrafluoroethylene polymer. The tetrafluoroethylene polymer is a polymer having repeating units arising from tetrafluoroethylene monomer, also referred to as TFE. The present tetrafluoroethylene polymer has such a high melt viscosity that the polymer does not flow in the molten state and is not melt-processible. In one embodiment, the tetrafluoroethylene polymer is a tetrafluoroethylene homopolymer, consisting of repeating units of the tetrafluoroethylene monomer, also generally known in this field as polytetrafluoroethylene, commonly abbreviated as PTFE. In one embodiment, the tetrafluoroethylene polymer is a tetrafluoroethylene homopolymer, consisting essentially of repeating units arising from the tetrafluoroethylene monomer. In another embodiment the tetrafluoroethylene polymer is a “modified” PTFE, referring to copolymers of tetrafluoroethylene with such a small concentration of comonomer that the molecular weight of the resultant polymer is not substantially reduced below that of homopolymer PTFE. The concentration of such comonomer in modified PTFE is less than 1 wt %, preferably less than 0.5 wt %. A minimum amount of at least about 0.05 wt % is generally used to have significant effect. Example comonomer in modified PTFE include perfluoroolefins, notably hexafluoropropylene (HFP) or perfluoro (alkyl vinyl ether) (PAVE), where the alkyl group contains 1 to 5 carbon atoms, with perfluoro (ethyl vinyl ether) (PEVE) and perfluoro (propyl vinyl ether) (PPVE) being preferred, chlorotrifluoroethylene (CTFE), perfluorobutyl ethylene (PFBE), or other similar monomers that introduce relatively sterically bulky side groups into the PTFE polymer chain.

The present tetrafluoroethylene polymer has a melt creep viscosity within the range of from about 0.5×10¹¹ poise to about 6.0×10¹¹ poise. In another embodiment, tetrafluoroethylene polymer has a melt creep viscosity of at least about 1.0×10¹¹ poise. In another embodiment, tetrafluoroethylene polymer has a melt creep viscosity of at least about 1.5×10¹¹ poise. In another embodiment, tetrafluoroethylene polymer has a melt creep viscosity of at least about 2.0×10¹¹ poise. In another embodiment, tetrafluoroethylene polymer has a melt creep viscosity of at least about 2.5×10¹¹ poise. In another embodiment, tetrafluoroethylene polymer has a melt creep viscosity of at least about 3.0×10¹¹ poise. In another embodiment, tetrafluoroethylene polymer has a melt creep viscosity of at least about 3.5×10¹¹ poise. In another embodiment, tetrafluoroethylene polymer has a melt creep viscosity of at least about 4.0×10¹¹ poise. In another embodiment, tetrafluoroethylene polymer has a melt creep viscosity of at least about 4.5×10¹¹ poise. In another embodiment, tetrafluoroethylene polymer has a melt creep viscosity of at least about 5.0×10¹¹ poise. In another embodiment, tetrafluoroethylene polymer has a melt creep viscosity of at least about 5.5×10¹¹ poise. In another embodiment, tetrafluoroethylene polymer has a melt creep viscosity of at least about 6.0×10¹¹ poise. Melt creep viscosity (MCV) is measured by the method described in Ebnesajjad, Sina, (2015), Fluoroplastics, Volume 1-Non-Melt Processible Fluoropolymers—The Definitive User's Guide and Data Book (2nd Edition), Appendix 5, Melt Creep Viscosity of Polytetrafluoroethylene, pp. 660-661, with reference to U.S. Pat. No. 3,819,594.

The present tetrafluoroethylene polymer is fibrillatable. By fibrillatable is meant that the tetrafluoroethylene polymer is capable of forming nanosized (in at least one dimension (i.e. <100 nm width)) fibrils which can vary in length from submicrometer, to several, to tens of micrometers in length when the tetrafluoroethylene polymer is subjected to shear forces, e.g., during practice of the present method.

### Second Polymer

The present fluoropolymer composition includes a second polymer different from the first tetrafluoroethylene polymer. The second polymer is one that is capable of forming an aqueous dispersion of fine particles of size substantially similar to that of the tetrafluoroethylene polymer aqueous dispersion, or has solubility in the aqueous phase of a tetrafluoroethylene polymer aqueous dispersion, and can come into contact with the tetrafluoroethylene polymer primary particles and influence the coagulation of the tetrafluoroethylene polymer primary particles during their coagulation to form agglomerates.

In one embodiment, the second polymer is selected from the group consisting of: fluoropolymers not including the first polymer (tetrafluoroethylene polymer), polyolefins, polyesters, polyamides, polyimides, polyaramides, polyacrylates, polyurethanes, polyethers, polyolethers, polyacrylonitriles, polyphosphazenes, polysiloxanes, polysulfides and polysulfones.

In one embodiment, the second polymer is selected from the group consisting of: tetrafluoroethylene polymers having a melt creep viscosity within the range of from about 0.5×10¹¹ poise to about 6.0×10¹¹ poise and being a tetrafluoroethylene polymer different from the first polymer; tetrafluoroethylene perfluoro (alkyl vinyl ether) copolymers (PFA); fluorinated ethylene propylene copolymers (FEP); fluoroelastomers (FKM); ethylene tetrafluoroethylene copolymers (ETFE); polyvinylidene fluoride polymers (PVDF); polychlorotrifluoroethylene polymers (CTFE); and polyvinyl fluoride (PVF) polymers.

In one embodiment, the second polymer is a tetrafluoroethylene polymer having a melt creep viscosity within the range of from about 0.5×10¹¹ poise to about 6.0×10¹¹ poise and is a tetrafluoroethylene polymer different from that of the first polymer comprising a tetrafluoroethylene polymer. In one embodiment, the first polymer comprising a tetrafluoroethylene polymer is a tetrafluoroethylene homopolymer, consisting of repeating units of the tetrafluoroethylene monomer, having a melt creep viscosity of at least about 3.0×10¹¹ poise, and the second polymer comprising a tetrafluoroethylene polymer is a modified PTFE, having concentration of comonomer repeating units less than 1 wt %, and having a melt creep viscosity of at least about 0.5 ×10¹¹ poise.

In a preferred embodiment the second polymer is tetrafluoroethylene perfluoro (alkyl vinyl ether) (PFA) copolymer. PFA is a copolymer of tetrafluoroethylene (TFE) and perfluoro (alkyl vinyl ether) (PAVE) monomers in which the PAVE monomer linear or branched perfluoroalkyl group contains 1 to 5 carbon atoms. Preferred PAVE monomers are those in which the perfluoroalkyl group contains 1, 2, 3 or 4 carbon atoms, respectively known as perfluoro(methyl vinyl ether) (PMVE), perfluoro (ethyl vinyl ether) (PEVE), perfluoro (propyl vinyl ether) (PPVE), and perfluoro (butyl vinyl ether) (PBVE). The PFA copolymer can be made using several PAVE monomers, such as the TFE/perfluoro(methyl vinyl ether)/perfluoro (propyl vinyl ether) copolymer, sometimes referred to as MFA in this field. The PFA may contain about 1-15 wt % PAVE, although a PAVE content of 2 to 8 wt %, preferably 3 to 5 wt %, is the most common PAVE content when a single PAVE monomer is used to form the PFA, the TFE forming the remainder of the copolymer. In one embodiment the MFA includes PMVE, and the composition is about 0.5 to 13 wt % PMVE and about 0.5 to 3 wt % PPVE, the remainder to total 100 wt % being TFE. Preferably, the identity and amount of PAVE present in the PFA is such that the melting temperature of the PFA is greater than about 300° C. The PFA is a fluoroplastic, not a fluoroelastomer. As a fluoroplastic, the PFA is semicrystalline, i.e. partially crystalline.

In one embodiment the PFA is melt processable and melt fabricable, i.e. the PFA is sufficiently flowable in the molten state that it can be fabricated by melt processing such as extrusion, to produce products having sufficient strength so as to be commercially useful. In one embodiment this sufficient strength may be characterized by the PFA by itself exhibiting an MIT Flex Life of at least 1,000 cycles, preferably at least 2,000 cycles as measured on 8 mil (0.21 mm) thick film. In the MIT Flex Life test, the film is gripped between jaws and is flexed back and forth over a 135° range. In this embodiment, the strength of the PFA is indicated by it not being brittle. In one embodiment, the melt flow rate (MFR) of the PFA is preferably at least 0.1 g/10 min, preferably at least 5 g/10 min, and even more preferably at least 7 g/10 min, as measured according to ASTM D-1238 and ASTM D 3307-93, at 372° C. using a 5 kg weight on the molten PFA.

In one embodiment the PFA is fluorine-treated so as to have the stable —CF₃ end group as the predominate end group and less than 50, preferably less than 25, total thermally unstable end groups, for example, —CONH₂, —COF, —CH₂OH and —COOH per 10⁶ carbon atoms as the most common end groups resulting from the aqueous dispersion polymerization process used to make the PFA. Processes for fluorination are known in the art, for example, in U.S. Pat. Nos. 4,743,658 and 6,838,545. According to one embodiment of the present invention, the PFA is not fluorine treated, whereby its end groups, about 200 or more per 10⁶ carbon atoms, are the unstable end groups mentioned above arising from aqueous dispersion polymerization to form the PFA.

In an alternate embodiment the second polymer is perfluorinated ethylene-propylene (FEP) copolymer, a copolymer of tetrafluoroethylene and hexafluoropropylene (HFP). In one embodiment, the HFP content is about 5 to about 17 weight percent in the FEP. In another embodiment, the FEP fluoropolymer comprises TFE/HFP/PAVE terpolymer wherein the HFP content is about 5 to about 17 weight percent and the PAVE content, preferably PEVE, is about 0.2 to about 4 weight percent, the balance being TFE, to total 100 weight percent for the fluoropolymer. In one embodiment, FEP fluoropolymer can be subjected to fluorination for the purpose of reducing the number of thermally unstable end groups (e.g., carboxylic acid end groups). The fluorination can be carried out by known methods with a variety of fluorine radical generating compounds under a variety of conditions as is known in the art, as discussed earlier herein relative to PFA.

In an alternate preferred embodiment, the second polymer is fluoroelastomer, including those known as FKM (fluoroelastomer) and FFKM (perfluoroelastomer).

In one embodiment, the second polymer is selected from the group consisting of the fluoroelastomers: vinylidene fluoride/hexafluoropropylene copolymer (VDF/HFP); vinylidene fluoride/hexafluoropropylene/tetrafluoroethylene copolymer (VDF/HFP/TFE); vinylidene fluoride/perfluoro(methyl vinyl ether)/tetrafluoroethylene copolymer (VDF/PMVE/TFE); tetrafluoroethylene/perfluoro(methyl vinyl ether) copolymer (TFE/PMVE); tetrafluoroethylene/propylene copolymer (TFE/P); and ethylene/tetrafluoroethylene/perfluoro(methyl vinyl ether) copolymer (E/TFE/PMVE).

In one embodiment, fluoroelastomers of utility in the present invention can be described as:
(A) vinylidene fluoride-based (VDF) fluoroelastomers, in which VDF is copolymerized with at least one additional comonomer selected from the group consisting of:
(i) C₂-C₈ perfluoroolefins, such as tetrafluoroethylene (TFE), hexafluoropropylene (HFP);
(ii) hydrogen-containing C₂-C₈ olefins, such as vinyl fluoride (VF), trifluoroethylene, hexafluoroisobutene, perfluoroalkyl ethylenes of formula CH₂λCH-R_{f}, wherein R_{f} is a C₁-C₆ perfluoroalkyl group;
(iii) C₂-C₈ fluoroolefins comprising at least one of iodine, chlorine and bromine, such as chlorotrifluoroethylene (CTFE);
(iv) (per)fluoroalkylvinylethers (PAVE) of formula CF₂═CFOR_{f}, wherein R_{f} is a C₁-C₆ (per)fluoroalkyl group, preferably —CF₃, —C₂F₅, —C₃F₇;
(v) (per)fluoro-oxy-alkylvinylethers of formula CF₂═CFOX, wherein X is a C₁-C₁₂ ((per)fluoro)-oxyalkyl comprising catenary oxygen atoms, e.g. the perfluoro-2-propoxypropyl group;
(vi) (per)fluorodioxoles;
(vii) (per)fluoro-methoxy-vinylethers having formula: CF₂═CFOCF₂OR_{f2}, wherein Rez is selected from the group consisting of C₁-C₆ (per)fluoroalkyls; C₅-C₆ cyclic (per)fluoroalkyls; and C₂-C₆ (per)fluorooxyalkyls, comprising at least one catenary oxygen atom; R_{f2} is preferably —CF₂CF₃; —CF₂CF₂OCF₃; or —CF₃;
(viii) C₂-C₈ non-fluorinated olefins, for example ethylene and propylene; and
(B) TFE-based fluoroelastomers, in which TFE is copolymerized with at least one additional comonomer selected from the group consisting of (i) through (viii) as described immediately above.

In a preferred embodiment the present fluoroelastomer is a vinylidene fluoride copolymer, more preferably a vinylidene fluoride, hexafluoropropylene and tetrafluoroethylene copolymer.

In an alternate embodiment the present fluoroelastomer binder is crosslinked. Crosslinking not only improves the mechanical properties of the polymer, but also helps provide good contact between the components of the present electrode compositions.

In some embodiments of the present fluoropolymer composition for use as binder in lithium-ion secondary battery electrode, the weight ratio of the tetrafluoroethylene polymer to the second polymer is from about 99:1 to about 25:75. In other embodiments, the ratio is from about 99:1 to about 50:50, or from about 99:1 to about 80:20, or from about 99:1 to about 90:10, or from about 99:1 to about 95:5, or from about 98:2 to about 92:8, or about 90:10, or about 95:5.

In a preferred embodiment, the second polymer is tetrafluoroethylene perfluoro (alkyl vinyl ether) (PFA) polymer and the weight ratio of the tetrafluoroethylene polymer to the tetrafluoroethylene perfluoro (alkyl vinyl ether) polymer is from about 99:1 to about 50:50, preferably from about 99:1 to about 90:10, or from about 98:2 to about 92:8, or about 95:5.

In a preferred embodiment, the second polymer is fluoroelastomer (FKM) and the weight ratio of the tetrafluoroethylene polymer to the fluoroelastomer is from about 99:1 to about 80:20, preferably from about 99:1 to about 90:10, or about 95:5. The present inventors discovered that binder comprising cocoagulated compositions of present tetrafluoroethylene polymer with present fluoroelastomer containing more than 20 weight percent of fluoroelastomer results in compositions that are rubbery and generally not fibrillatable, and so are undesirable for utility as binder in lithium-ion secondary battery electrodes made by a present dry manufacturing process. Further, the present inventors discovered that above about 12 weight percent of fluoroelastomer is generally the upper bound to making a free-flowing dry friable agglomerate powder, which is desirable feature from the standpoint of a commercially viable electrode manufacturing process.

### Electrode Composition Manufacturing Method-Cocoagulation and Milling

The present invention includes a method for manufacturing an electrode composition for use in a lithium-ion secondary battery electrode, comprising:
I.) cocoagulating:
   I.-i) an aqueous dispersion of first polymer comprising unfibrillated tetrafluoroethylene polymer having a melt creep viscosity of at least about 0.5×10¹¹ poise; and
   I.-ii) a second polymer different from the first polymer, to produce friable agglomerates of the first and second polymers;
II.) separating the friable agglomerates formed in I.) from the aqueous phase;
III.) drying the friable agglomerates separated in II.); and
   thereby forming dry friable agglomerates comprising particles of the first polymer and the second polymer.

The present invention further includes a method for manufacturing an electrode composition for use in a lithium-ion secondary battery electrode, comprising the step of: IV.) milling electrode active particles together with the present dry friable agglomerates comprising particles of the first polymer and the second polymer to form an electrode composition.

The present invention further includes a method for manufacturing an electrode composition for use in a lithium-ion secondary battery electrode, comprising the steps I.) through III.) recited above, and further the step of:
IV.) milling dry electrode active particles together with the dry friable agglomerates formed in III.) to form the present electrode composition.

The present method includes a step of cocoagulating: I.-i) an aqueous dispersion of particles of first polymer comprising unfibrillated tetrafluoroethylene polymer; and I.-ii) a second polymer different from the first polymer, to produce friable agglomerates comprised of the first and second polymers.

Methods for coagulating aqueous dispersions of tetrafluoroethylene polymer primary particles to form agglomerates are known in the art, for example U.S. Pat. No. 7,947,775 B1. Such conventional methods for coagulation of aqueous dispersions of tetrafluoroethylene polymer primary particles can be utilized in the cocoagulation step of the present method. In the present method, an aqueous dispersion of first polymer comprising unfibrillated tetrafluoroethylene polymer primary particles is coagulated in the presence of the second polymer different from the first polymer. In one embodiment of the present cocoagulation, the second polymer is in the form of an aqueous dispersion, capable of being coagulated, and the aqueous dispersions of first and second polymers are combined, mixed, and this mixture of first and second polymer aqueous dispersions is then cocoagulated.

In one embodiment, I.) cocoagulating is carried out using an aqueous dispersion of primary particles of the first polymer and an aqueous dispersion of particles of the second polymer, and the friable agglomerates formed by this cocoagulation comprise particles of the first polymer and particles of the second polymer.

In another embodiment, I.) cocoagulating is carried out using an aqueous dispersion of primary particles of the first polymer, and an aqueous solution of the second polymer, and the friable agglomerates comprise particles of the first polymer having at least a partial coating comprising the second polymer.

In a further embodiment, I.) cocoagulating is carried out using an aqueous dispersion of primary particles of the first polymer and an aqueous dispersion of particles of a second polymer (SP1), and also an aqueous solution of a second polymer (SP2). In this embodiment the second polymer of SP1 and SP2 are the same, or different. The friable agglomerates formed by this cocoagulation comprise particles of the first polymer and SP1, and also particles of the first polymer having at least a partial coating comprising SP2.

Aqueous dispersions of tetrafluoroethylene polymer can be manufactured by known methods and are also commercially available, for example from Chemours FC LLC. Dispersion processes for polymerizing fluorinated monomers in aqueous media are known established commercial technology, for example as disclosed in U.S. Pat. No. 6,429,258 B1, PCT patent application WO_{2008/060461} A1, and published US patent application US2009/0281241 A1, all of which are herein incorporated by reference. Aqueous dispersion processes for manufacture of tetrafluoroethylene polymer employs a surfactant, also referred to as dispersant, to provide dispersion stability and permit the fluoromonomer polymerization to be carried to commercially acceptable solids concentrations at commercially acceptable production rates.

Aqueous dispersion polymerization processes using a surfactant for the manufacture of tetrafluoroethylene polymer are known to result in predominately spherical primary particles (primary particles referring to the as-polymerized particles) having raw dispersion particle size (RDPS) in the range of from about 5 nm to about 250 nm, preferably from about 10 nm to about 200 nm, and more preferably from about 25 nm to about 150 nm. Rod-shaped dispersion particles (length to diameter, or L/D, ratios of greater than 3.0) may be formed if the molecular weight of the tetrafluoroethylene polymer is very high (not melt fabricable) and the amount of modifying comonomer, if any, is small, that is not more than 0.3 mole %. Dispersion particles with L/D values of greater than 3.0 are sometimes formed during polymerization of high molecular weight tetrafluoroethylene polymer, but the levels are generally low, about 10 to 15 weight %, and the L/D Values are low, less than 10, usually less than 5, unless the fluorosurfactant level is very high, generally higher than the surfactant critical micelle concentration value.

Aqueous dispersions of second polymer particles and/or solutions of second polymer for use in the present method are commercially available or otherwise known in the art and can be purchased or manufactured by known methods.

The present cocoagulation can be carried out by known processes, such as combining and mixing a first polymer aqueous dispersion and a second polymer in the form of an aqueous dispersion or other suspended fine particulate form, followed by vigorous agitation (mechanical cocoagulation), optionally supplemented by addition of electrolyte and/or water-immiscible solvent having low surface tension (chemical cocoagulation), or by freeze-thaw procedures. Diluting a raw aqueous dispersion to a polymer concentration of about 10 to about 20 weight percent and optionally adjusting the pH to neutral or basic can also be used to carry out the present cocoagulation. A coagulating agent such as a water-soluble organic compound or inorganic salt or acid can be added to the dispersion. Coagulation is helped by adding a water-soluble organic compound (e.g., methanol, acetone), an inorganic salt (e.g., potassium nitrate, ammonium carbonate), and an inorganic acid (e.g., hydrochloric acid, sulfuric acid, nitric acid) as a coagulating agent. The diluted dispersion is then agitated and/or stirred vigorously resulting in cocoagulation of the first polymer and second polymer.

In a preferred embodiment, the present cocoagulation method is carried out by chemical cocoagulation, for example using ammonium carbonate solution, combined with mechanical stirring. The present inventors discovered that the results of such process (as reported in the present Examples) surprisingly show that smaller and more friable agglomerates are obtained using chemical cocoagulation as compared to mechanical cocoagulation alone.

Primary (as-polymerized) tetrafluoroethylene copolymer particles formed in aqueous dispersion polymerization processes typically have raw dispersion particle size (RDPS) in the range of from about 5 nm to about 250 nm. Tetrafluoroethylene copolymer cocoagulation with the present second polymer results in the formation of friable agglomerates having an average particle size of from about 200 to about 1000 micrometers, preferably from about 200 to about 500 micrometers.

In a preferred embodiment, the present agglomerates resulting from the present l.) cocoagulating step are comprised of i.) tetrafluoroethylene polymer primary particles and tetrafluoroethylene perfluoro (alkyl vinyl ether) polymer primary particles, or ii.) tetrafluoroethylene polymer primary particles and fluoroelastomer primary particles. In an alternate embodiment, the present agglomerates resulting from the present I.) cocoagulating step consist essentially i.) tetrafluoroethylene polymer primary particles and tetrafluoroethylene perfluoro (alkyl vinyl ether) polymer primary particles, or ii.) tetrafluoroethylene polymer primary particles and fluoroelastomer primary particles. In an alternate embodiment, the present agglomerates resulting from the present I.) cocoagulating step consist of i.) tetrafluoroethylene polymer primary particles and tetrafluoroethylene perfluoro (alkyl vinyl ether) polymer primary particles, or ii.) tetrafluoroethylene polymer primary particles and fluoroelastomer primary particles . . .

The present method includes a step of II.) separating the friable agglomerates (formed in the I.) cocoagulating step) from the aqueous phase. The present agglomerates formed in the present cocoagulation step can be separated from the aqueous phase by conventional techniques, such as skimming or filtration.

The present method includes a step of III.) drying the friable agglomerates (formed in the II.) separating step). Drying of the agglomerates can be carried out by vacuum, high frequency, or heated air such that the wet powder is not excessively fluidized. Excessive friction or contact between the particles, especially at a high temperature, can adversely affect the agglomerates due to possible fibrillation and resulting loss of particulate structure leading to potentially poorer properties of electrode compositions and films made from the agglomerates. Drying temperatures of utility typically range from about 100 to about 180° C.

In one embodiment, the present dry friable agglomerates are protected from fibrillation after drying. The present tetrafluoroethylene polymers do not fibrillate below their beta transition point (about 19° C. for tetrafluoroethylene homopolymers) during normal handling and transportation. In one embodiment, the present agglomerates are stored and handled at temperatures below the transition point.

The agglomerates formed by the present method steps I. through III. are herein referred to as “friable” agglomerates. As used herein, the term friable or friability, is defined by the ability of the agglomerates to be deagglomerated and comminuted so as to more closely match the particle size of conventional solid phase electrode active materials, and to be homogeneously compounded and mixed with solid phase electrode active materials, by application of shear force, without substantially fibrillating the tetrafluoroethylene polymer. The present inventors believe that by more closely matching the particle size of the present friable agglomerates and particles obtained therefrom with conventional solid phase electrode active materials, results in more homogeneously compounded and mixed electrode binder compositions, which in turn enables the manufacture of higher loading electrode structures with reversible capacity retention. This surprising and beneficial result is indeed observed and reported in the present Experimental results.

In one embodiment, shear force applied to the present agglomerates results in deagglomeration and comminution of the agglomerates to form secondary or sub-agglomerates having an average particle size of from about 10 to about 300 micrometers, wherein the tetrafluoroethylene polymer is substantially unfibrillated. In another embodiment, shear force applied to the agglomerates results in deagglomeration and comminution of the agglomerates to form secondary or sub-agglomerates having an average particle size of from about 10 to about 60 micrometers, wherein the tetrafluoroethylene polymer is substantially unfibrillated.

The present method includes a step of IV.) milling electrode active particles together with the dry friable agglomerates (formed in the III.) drying step) to form the present electrode compositions.

The present method milling step IV.) is carried out sufficient to deagglomerate and comminute the tetrafluoroethylene and second/other polymer agglomerates, resulting in formation of secondary, smaller agglomerates. In one embodiment the secondary agglomerates have an average particle size of from about 10 to about 300 micrometers. In another embodiment, the secondary agglomerates have an average particle size of from about 10 to about 60 micrometers.

The present method milling step IV.) is carried out sufficient for the agglomerates to deagglomerate and comminute to secondary agglomerates having a particle size substantially similar to that of the electrode active particles, and for the electrode particles and the secondary agglomerates to be homogeneously mixed.

In the present method, the tetrafluoroethylene polymer is substantially unfibrillated during the I.) cocoagulating, II.) separating and III.) drying steps, and is substantially fibrillated during the IV.) milling step in the presence of, and in intimate contact with, the electrode active particles.

The milling step of the present method can be carried out by known processes for milling and applying mixing and high shear forces to fine powders. For example, techniques and machinery that are envisioned for potential use to provide high shear forces to effectuate the present step of IV.) milling include jet-milling, pin milling, impact pulverization, and hammer milling, and similar techniques and apparatus. In one embodiment, jet milling is preferred, as generally taught in U.S. Pat. No. 7,342,770 B2, herein incorporated by reference.

In one embodiment, the present method further comprises, between step III.) drying and step IV.) milling, a step of pre-milling the dry friable agglomerates obtained following step III.) sufficient to deagglomerate and comminute the dry friable agglomerates without substantially fibrillating said tetrafluoroethylene polymer. In one embodiment, the pre-milling results in formation of secondary agglomerates having an average particle size of from about 10 to about 300 micrometers. In another embodiment, the pre-milling results in formation of secondary agglomerates having an average particle size of from about 10 to about 60 micrometers. These secondary agglomerates are then used in the present method milling step IV.).

In all embodiments of the present method, the milling step IV.) is carried out substantially dry and free from solvent. For example, free from water, and organic solvents such as “NMP” N-methyl-2-pyrrolidone commonly used as carriers in battery binder manufacturing processes.

### Lithium-Ion Secondary Battery Electrode Film Compositions

The present invention includes a composition for use in a lithium-ion secondary battery cathode film, comprising: i.) cathode active particles comprising lithium transition metal oxide; ii.) conductive carbon; and iii.) fluoropolymer binder comprising a mixture of particles of tetrafluoroethylene polymer having a melt creep viscosity of at least about 0.5×10¹¹ poise, and second polymer different from the first polymer; wherein said tetrafluoroethylene polymer is fibrillated.

The present invention further includes a composition for use in a lithium-ion secondary battery cathode film, comprising: i.) cathode active particles comprising lithium transition metal oxide; ii.) conductive carbon; and iii.) fluoropolymer binder comprising a mixture of particles of tetrafluoroethylene polymer having a melt creep viscosity of at least about 0.5×10¹¹ poise, and particles of tetrafluoroethylene perfluoro (alkyl vinyl ether) polymer; wherein said tetrafluoroethylene polymer is fibrillated.

The present invention further includes a composition for use in a lithium-ion secondary battery cathode film, comprising: i.) cathode active particles comprising lithium transition metal oxide; ii.) conductive carbon; and iii.) fluoropolymer binder comprising a mixture of particles of tetrafluoroethylene polymer having a melt creep viscosity of at least about 0.5×10¹¹ poise, and particles of fluoroelastomer (FKM); wherein said tetrafluoroethylene polymer is fibrillated.

In one embodiment, the cathode film composition contains from about 1 to about 10 weight percent fluoropolymer binder, from about 95 to about 98 weight percent cathode active particles, and from about 1 to about 10 weight percent conductive carbon, based on the combined weight of the fluoropolymer binder, the cathode active particles, and the conductive carbon.

The present cathode active particles are selected from electrochemical cathode active materials known in this field. Example cathode active particles include metal oxide, metal sulfide, or a lithium metal oxide. In a preferred embodiment, the cathode active particles comprise a lithium transition metal oxide. Example lithium metal oxides include: lithium nickel manganese cobalt oxide (NMC), lithium manganese oxide (LMO), lithium iron phosphate (LiFePO₄), lithium cobalt oxide (LCO), lithium titanate (LTO), and/or lithium nickel cobalt aluminum oxide (NCA). In some embodiments, cathode active materials can comprise, for example, a layered transition metal oxide (such as LiCoO₂ (LCO), Li(NiMnCo)O₂ (NMC), LiNi_{0.8}CO_{0.15}Al_{0.05}O₂ (NCA)), spinel manganese oxide (such as LiMn₂O₄ (LMO), LiMn_{1.5}Ni_{0.5}O₄ (LMNO)) or an olivine (such as LiFePO₄), LiNiO₂, LiNi₁₋ₓCoₓO₂, LiNi_{0.85}Co_{0.1}Al_{0.05}O₂, LiNi_{0.33}Co_{0.33}Mn_{0.33}O₂, LiMn₂O₄, and combinations thereof.

The present conductive carbon of utility in the cathode embodiment is selected from electro-conductive carbon materials known in this field. Example conductive carbon materials of utility include carbon black, porous carbon, carbon nanotubes, carbon fiber, VGCF (vapor grown carbon fiber), graphene sheets, acetylene black, and combinations thereof.

The present invention includes a composition for use in a lithium-ion secondary battery anode film, comprising: i.) anode active particles; and ii.) fluoropolymer binder comprising a mixture of particles of tetrafluoroethylene polymer having a melt creep viscosity of at least about 0.5×10¹¹ poise, and second polymer different from the first polymer; wherein said tetrafluoroethylene polymer is fibrillated.

The present invention further includes a composition for use in a lithium-ion secondary battery anode film, comprising: i.) anode active particles; and ii.) fluoropolymer binder comprising a mixture of particles of tetrafluoroethylene polymer having a melt creep viscosity of at least about 0.5×10¹¹ poise, and particles of tetrafluoroethylene perfluoro (alkyl vinyl ether) polymer; wherein said tetrafluoroethylene polymer is fibrillated.

The present invention further includes a composition for use in a lithium-ion secondary battery anode film, comprising: i.) anode active particles; and ii.) fluoropolymer binder comprising a mixture of particles of tetrafluoroethylene polymer having a melt creep viscosity of at least about 0.5×10¹¹ poise, and particles of fluoroelastomer (FKM); wherein said tetrafluoroethylene polymer is fibrillated.

In one embodiment, the anode film composition contains from about 1 to about 10 weight percent fluoropolymer binder, and from about 90 to about 99 weight percent anode active particles.

The present anode active particles are selected from conventional materials known in this field, for example, graphite, graphene, lithium titanate and silicon or silicon-containing materials.

### Lithium-Ion Secondary Batteries-Cathode Embodiment

The present invention includes a lithium-ion secondary battery comprising:
1) a cathode comprising: a cathode electrode layer adhered to a metal current collector, said cathode electrode layer comprising a cathode electrode composition comprising:
   a) cathode active particles comprising lithium transition metal oxide;
   b) conductive carbon; and
   c) fluoropolymer binder comprising a mixture of:
      i) particles of tetrafluoroethylene polymer having a melt creep viscosity of at least about 0.5×10¹¹ poise; and
      ii) particles of a second polymer;
2) an anode;
3) a separator between said cathode and said anode; and
4) an electrolyte in communication with said cathode, anode and separator.

The present inventors have discovered that this present battery cathode embodiment has a higher discharge specific capacity at a given C rate for C rates greater than or equal to C/2, than an identical battery wherein said fluoropolymer binder contains no said second polymer. In one embodiment, the battery has an at least 50% higher discharge specific capacity at a given C rate for C rates greater than or equal to C/2, than an identical battery wherein said fluoropolymer binder contains no said second polymer. In another embodiment, the battery has an at least 100% higher discharge specific capacity at a given C rate for C rates greater than or equal to C/2, than an identical battery wherein said fluoropolymer binder contains no said second polymer. In another embodiment, the battery has an at least 150% higher discharge specific capacity at a given C rate for C rates greater than or equal to C/2, than an identical battery wherein said fluoropolymer binder contains no said second polymer. In another embodiment, the battery has an at least 200% higher discharge specific capacity at a given C rate for C rates greater than or equal to C/2, than an identical battery wherein said fluoropolymer binder contains no said second polymer. In another embodiment, battery has an at least 250% higher discharge specific capacity at a given C rate for C rates greater than or equal to C/2, than an identical battery wherein said fluoropolymer binder contains no said second polymer.

In one embodiment of the battery containing a present inventive cathode, the fluoropolymer binder is prepared by cocoagulation of an aqueous dispersion of tetrafluoroethylene polymer and an aqueous dispersion of second polymer. In an alternate embodiment of the present battery containing a present inventive cathode, the fluoropolymer binder is prepared by I.) cocoagulating an aqueous dispersion of tetrafluoroethylene polymer and an aqueous dispersion of second polymer to produce friable agglomerates of tetrafluoroethylene polymer and second polymers; II.) separating the agglomerates from the aqueous phase; and III.) drying the agglomerates. In one embodiment of the present battery containing a present inventive cathode, the cocoagulation is chemical cocoagulation.

In one embodiment of the battery containing a present inventive cathode, the friability of the agglomerates is characterized by the ability of the agglomerates to be deagglomerated and comminuted by application of shear force without substantially fibrillating said tetrafluoroethylene polymer. In one embodiment, shear force applied to the agglomerates results in deagglomeration and comminution of the agglomerates without substantially fibrillating the tetrafluoroethylene polymer to form secondary agglomerates having an average particle size of from about 10 to about 300 micrometers. In another embodiment, shear force applied to the agglomerates results in deagglomeration and comminution of the agglomerates without substantially fibrillating the tetrafluoroethylene polymer to form secondary agglomerates having an average particle size of from about 10 to about 60 micrometers.

In one embodiment of the battery containing a present inventive cathode, the second polymer is selected from the group consisting of: fluoropolymers having a melt creep viscosity different from that of said first polymer, polyolefins, polyesters, polyamides, polyimides, polyaramides, polyacrylates, polyurethanes, polyethers, polyolethers, polyacrylonitriles, polyphosphazenes, polysiloxanes, polysulfides and polysulfones.

In one embodiment of the battery containing a present inventive cathode, the second polymer is selected from the group consisting of: tetrafluoroethylene polymers having a melt creep viscosity different from that of said first polymer, tetrafluoroethylene perfluoro (alkyl vinyl ether) (PFA), fluorinated ethylene propylene (FEP), fluoroelastomer (FKM), ethylene tetrafluoroethylene polymer (ETFE), polyvinylidene fluoride (PVDF), polychlorotrifluoroethylene (CTFE), and polyvinyl fluoride (PVF). In a preferred embodiment, the second polymer comprises particles of tetrafluoroethylene perfluoro (alkyl vinyl ether) polymer, particles of fluoroelastomer (FKM), or their combination.

In one embodiment of the battery containing a present inventive cathode, the cathode electrode composition is prepared by milling the cathode active particles, the conductive carbon, and dry friable agglomerates comprising the fluoropolymer binder, whereby the tetrafluoroethylene polymer is fibrillated. In a preferred embodiment the milling is carried out substantially free from solvent.

In one embodiment of the battery containing a present inventive cathode, the cathode electrode composition contains from about 1 to about 10 weight percent fluoropolymer binder, from about 95 to about 98 weight percent cathode active particles, and from about 1 to about 10 weight percent conductive carbon, based on the combined weight of the fluoropolymer binder, the cathode active particles, and the conductive carbon.

In one embodiment of the battery containing a present inventive cathode, the weight ratio of the tetrafluoroethylene polymer to the second polymer is from about 99:1 to about 25:75. In other embodiments, the ratio is from about 99:1 to about 50:50, or from about 99:1 to about 80:20, or from about 99:1 to about 90:10, or from about 99:1 to about 95:5, or from about 98:2 to about 92:8, or about 90:10, or about 95:5. In a preferred embodiment, the second polymer is tetrafluoroethylene perfluoro (alkyl vinyl ether) (PFA) polymer and the weight ratio of the tetrafluoroethylene polymer to the tetrafluoroethylene perfluoro (alkyl vinyl ether) polymer is from about 99:1 to about 50:50, preferably from about 99:1 to about 90:10, or from about 98:2 to about 92:8, or about 95:5. In another preferred embodiment, the second polymer is fluoroelastomer (FKM) and the weight ratio of the tetrafluoroethylene polymer to the fluoroelastomer is from about 99:1 to about 80:20, preferably from about 99:1 to about 90:10, or about 95:5.

In one embodiment of the battery containing a present inventive cathode, the tetrafluoroethylene polymer is selected from the group consisting of A) tetrafluoroethylene homopolymer consisting essentially of tetrafluoroethylene monomer repeating units, and B) modified tetrafluoroethylene polymer consisting essentially of tetrafluoroethylene monomer repeating units and about 1 weight percent or less modifying perfluoro (alkyl vinyl ether) comonomer repeating units, and the second polymer comprises tetrafluoroethylene perfluoro (alkyl vinyl ether) polymer.

In one embodiment, the present invention includes a lithium-ion secondary battery having an inventive cathode, comprising:
1) a cathode comprising: a cathode electrode layer adhered to a metal current collector, said cathode electrode layer comprising a cathode electrode composition comprising:
a) cathode active particles comprising lithium transition metal oxide;
b) conductive carbon; and
c) fluoropolymer binder comprising a mixture of:
   i) particles of tetrafluoroethylene perfluoro (alkyl vinyl ether) polymer; and
   ii) particles of tetrafluoroethylene polymer; wherein said tetrafluoroethylene polymer:
      (1) is selected from the group consisting of:
         (a) tetrafluoroethylene homopolymer consisting essentially of tetrafluoroethylene monomer repeating units, and
         (b) modified tetrafluoroethylene polymer consisting essentially of tetrafluoroethylene monomer repeating units and about 1 weight percent or less modifying perfluoro (alkyl vinyl ether) comonomer (modifier) repeating units,
      (2) has melt creep viscosity of at least about 0.5×10¹¹ poise; and
      (3) is fibrillated;
2) an anode;
3) a separator between said cathode and said anode; and
4) an electrolyte in communication with said cathode, anode and separator.

### Lithium-Ion Secondary Batteries-Anode Embodiment

The present invention includes a lithium-ion secondary battery comprising:
1) an anode comprising: an anode electrode layer adhered to a metal current collector, said anode electrode layer comprising an anode electrode composition comprising:
   a) anode active particles; and
   b) fluoropolymer binder comprising a mixture of:
      i) particles of tetrafluoroethylene polymer having melt creep viscosity of at least about 0.5×10¹¹ poise; and
      ii) particles of second polymer;
2) a cathode;
3) a separator between said cathode and said anode; and
4) an electrolyte in communication with said cathode, anode and separator.

The present inventors have discovered that the present battery anode embodiment has a higher delithiation capacity (mAh/g) at a given C rate than an identical battery wherein the fluoropolymer binder contains no second polymer. In one embodiment, the battery has an at least 3% higher delithiation capacity (mAh/g) at a given C rate than an identical battery wherein the fluoropolymer binder contains no second polymer. In another embodiment, the battery has an at least 5% higher delithiation capacity (mAh/g) at a given C rate than an identical battery wherein the fluoropolymer binder contains no second polymer. In another embodiment, the battery has an at least 7% higher delithiation capacity (mAh/g) at a given C rate than an identical battery wherein the fluoropolymer binder contains no second polymer. In another embodiment, the battery has an at least 10% higher delithiation capacity (mAh/g) at a given C rate than an identical battery wherein the fluoropolymer binder contains no second polymer.

The present inventors have discovered that in the present battery anode embodiment, the anode exhibits by cyclic voltammetry measurement an electrochemical reduction between 0.25 V and 0.9 V versus Li/Li+ that is decreased relative to an anode in an identical battery wherein the fluoropolymer binder contains no second polymer. In one embodiment, the anode exhibits by cyclic voltammetry measurement an electrochemical reduction between 0.25 V and 0.9 V versus Li/Li+ that is decreased by at least about 30% relative to an anode in an identical battery wherein the fluoropolymer binder contains no second polymer. In another embodiment, the anode exhibits by cyclic voltammetry measurement an electrochemical reduction between 0.25 V and 0.9 V versus Li/Li+ that is decreased by at least about 40% relative to an anode in an identical battery wherein the fluoropolymer binder contains no second polymer. In another embodiment, the anode exhibits by cyclic voltammetry measurement an electrochemical reduction between 0.25 V and 0.9 V versus Li/Li+ that is decreased by at least about 50% relative to an anode in an identical battery wherein the fluoropolymer binder contains no second polymer. In another embodiment, the anode exhibits by cyclic voltammetry measurement an electrochemical reduction between 0.25 V and 0.9 V versus Li/Li+ that is decreased by at least about 60% relative to an anode in an identical battery wherein the fluoropolymer binder contains no second polymer.

In one embodiment of the battery containing a present inventive anode, the fluoropolymer binder is prepared by cocoagulation of an aqueous dispersion of the tetrafluoroethylene polymer and an aqueous dispersion of the second polymer. In an alternate embodiment, the fluoropolymer binder is prepared by I.) cocoagulating an aqueous dispersion of the tetrafluoroethylene polymer and an aqueous dispersion of the second polymer to produce friable agglomerates of the tetrafluoroethylene polymer and second polymers; II.) separating the agglomerates from the aqueous phase; and III.) drying the agglomerates. In a preferred embodiment, the cocoagulation is chemical cocoagulation.

In one embodiment of the battery containing a present inventive anode, the friability of the agglomerates is characterized by the ability of the agglomerates to be deagglomerated and comminuted by application of shear force without substantially fibrillating the tetrafluoroethylene polymer. In one embodiment, shear force applied to the agglomerates results in deagglomeration and comminution of the agglomerates without substantially fibrillating the tetrafluoroethylene polymer to form secondary agglomerates having an average particle size of from about 10 to about 300 micrometers. In another embodiment, shear force applied to the agglomerates results in deagglomeration and comminution of the agglomerates without substantially fibrillating the tetrafluoroethylene polymer to form secondary agglomerates having an average particle size of from about 10 to about 60 micrometers.

In one embodiment of the battery containing a present inventive anode, the second polymer is selected from the group consisting of: fluoropolymers having a melt creep viscosity different from that of said first polymer, polyolefins, polyesters, polyamides, polyimides, polyaramides, polyacrylates, polyurethanes, polyethers, polyolethers, polyacrylonitriles, polyphosphazenes, polysiloxanes, polysulfides and polysulfones.

In one embodiment of the battery containing a present inventive anode, the second polymer is selected from the group consisting of: tetrafluoroethylene polymers having a melt creep viscosity different from that of the first polymer, tetrafluoroethylene perfluoro (alkyl vinyl ether) (PFA), fluorinated ethylene propylene (FEP), fluoroelastomer (FKM), ethylene tetrafluoroethylene polymer (ETFE), polyvinylidene fluoride (PVDF), polychlorotrifluoroethylene (CTFE), and polyvinyl fluoride (PVF). In a preferred embodiment, the second polymer comprises particles of tetrafluoroethylene perfluoro (alkyl vinyl ether) polymer, or particles of fluoroelastomer (FKM), or their combination.

In one embodiment of the battery containing a present inventive anode, the anode electrode composition is prepared by milling the anode active particles and dry friable agglomerates comprising the fluoropolymer binder, whereby the fluoropolymer binder is fibrillated. In a preferred embodiment, milling is carried out substantially free from solvent.

In one embodiment of the battery containing a present inventive anode, the anode electrode composition contains from about 1 to about 10 weight percent fluoropolymer binder and from about 90 to about 99 weight percent anode active particles.

In one embodiment of the battery containing a present inventive anode, the weight ratio of the tetrafluoroethylene polymer to the second polymer is from about 99:1 to about 25:75. In other embodiments, the ratio is from about 99:1 to about 50:50, or from about 99:1 to about 80:20, or from about 99:1 to about 90:10, or from about 99:1 to about 95:5, or from about 98:2 to about 92:8, or about 90:10, or about 95:5. In a preferred embodiment, the second polymer is tetrafluoroethylene perfluoro (alkyl vinyl ether) (PFA) polymer and the weight ratio of the tetrafluoroethylene polymer to the tetrafluoroethylene perfluoro (alkyl vinyl ether) polymer is from about 99:1 to about 50:50, preferably from about 99:1 to about 90:10, or from about 98:2 to about 92:8, or about 95:5. In another preferred embodiment, the second polymer is fluoroelastomer (FKM) and the weight ratio of the tetrafluoroethylene polymer to the fluoroelastomer is from about 99:1 to about 80:20, preferably from about 99:1 to about 90:10, or about 95:5.

### Lithium-Ion Secondary Batteries-Cathode and Anode Embodiment

In one embodiment, the present invention includes a lithium-ion secondary battery having an inventive cathode and anode, comprising:
1) a cathode comprising: a cathode electrode layer adhered to a metal current collector, said cathode electrode layer comprising a cathode electrode composition comprising:
   a. cathode active particles comprising lithium transition metal oxide;
   b. conductive carbon; and
   c. fluoropolymer binder comprising a mixture of:
      i. particles of tetrafluoroethylene perfluoro (alkyl vinyl ether) polymer; and
      ii. particles of tetrafluoroethylene polymer; wherein said tetrafluoroethylene polymer:
         1. is selected from the group consisting of:
         a. tetrafluoroethylene homopolymer consisting essentially of tetrafluoroethylene monomer repeating units, and
         b. modified tetrafluoroethylene polymer consisting essentially of tetrafluoroethylene monomer repeating units and about 1 weight percent or less modifying perfluoro (alkyl vinyl ether) comonomer (modifier) repeating units,
         2. has melt creep viscosity of at least about 0.5×10¹¹ poise; and
         3. is fibrillated;
2) an anode comprising: an anode electrode layer adhered to a metal current collector, said anode electrode layer comprising an anode electrode composition comprising:
   a. anode active particles; and
   b. fluoropolymer binder comprising a mixture of:
      iii. particles of tetrafluoroethylene perfluoro (alkyl vinyl ether) polymer or particles of fluoroelastomer (FKM); and
      iv. particles of tetrafluoroethylene polymer; wherein said tetrafluoroethylene polymer:
         1. has melt creep viscosity of at least about 0.5×10¹¹ poise; and
         2. is fibrillated;
3) a separator between the cathode and the anode; and
4) an electrolyte in communication with the cathode, anode and separator.

### Electrolytes

Electrolytes of the present lithium-ion secondary batteries include conventional electrolytes for lithium-ion secondary batteries capable of continuous operation of the present battery without performance degradation. The electrolyte facilitates ionic communication between the electrodes of the present battery, and is typically in contact with the cathode, anode and the separator. In one embodiment, present batteries use a suitable lithium-containing electrolyte. For example, a lithium salt, and a solvent, such as a non-aqueous or organic solvent, or fluorinated organic solvent. Generally, the lithium salt includes an anion that is redox stable. In some embodiments, the anion can be monovalent. In some embodiments, a lithium salt can be selected from hexafluorophosphate (LiPF₆), lithium tetrafluoroborate (LiBF₄), lithium perchlorate (LiCIO₄), lithium bis(trifluoromethansulfonyl)imide (LiN(SO₂CF₃)₂), lithium trifluoromethansulfonate (LiSO₃CF₃), lithium bis(oxalate) borate (LiBOB) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 1 M. In certain embodiments, the salt concentration of the electrolyte can be about 0.2 M, about 0.3 M, about 0.4 M, about 0.5 M, about 0.6 M, about 0.7 M, about 0.8 M, about 0.9 M, about 1 M, about 1.1 M, about 1.2 M, or any range of values therebetween.

In some embodiments of the present lithium-ion secondary batteries, electrolytes include a liquid solvent. In further embodiments, the solvent can be an organic solvent. In some embodiments, a solvent can include one or more functional groups selected from carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), methyl (2,2,2-trifluoroethyl) carbonate (FEMC) and combinations thereof, or acyclic carbonates such as, for example, dimethyl carbonate (DMC), diethyl carbonate (DEC), ethyl methyl carbonate (EMC), and combinations thereof. In certain embodiments, the electrolyte can comprise LiPF₆, and one or more carbonates. An example organic solvent electrolyte includes the electrolyte known in this field as “Gen 2” electrolyte, which is 1.0 M LiPF₆ in ethylene carbonate (EC) and ethylmethyl carbonate (EMC), EC: EMC ratio of 3:7 by weight. In one embodiment, electrolyte for use in a high voltage lithium-ion secondary battery is a fluorinated organic solvent electrolyte. For example, fluorinated electrolyte referred to as FEC-FEMC, which is 1 M LiPF₆ in fluoroethylene carbonate (FEC) and methyl (2,2,2-trifluoroethyl) carbonate (FEMC), having an FEC: FEMC ratio of 1:9 by volume.

### Separators

Separators of the present lithium-ion secondary batteries include conventional separators for lithium-ion secondary batteries capable of continuous operation of the present battery without performance degradation. The separator is configured to electrically insulate two electrodes adjacent to opposing sides of the separator, while permitting ionic communication between the two adjacent electrodes. The separator can comprise a suitable porous, electrically insulating material. In some embodiments, the separator can comprise a polymeric material. For example, the separator can comprise a cellulosic material (e.g., paper), a polyethylene resin, a polypropylene resin and/or mixtures thereof.

### Examples

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Materials

Comparative example PFA1: copolymer of tetrafluoroethylene (TFE) and perfluoro (propyl vinyl ether) (PPVE), PPVE content 4 weight percent, having a melt flow rate of 15 g/10 minutes, and having total carboxylic acid type unstable ends content of about 200 per 10⁶ C atoms. Manufactured by Chemours FC LLC.

Comparative example FKM1: copolymer of vinylidene fluoride (VDF) and hexafluoropropylene (HFP), HFP content 40 weight percent and having a Mooney viscosity of 114 MU, measured at 121 C. Manufactured by Chemours FC LLC.

Comparative example FKM2: copolymer of tetrafluoroethylene and perfluoro(methyl vinyl ether) PMVE, PMVE content 45 weight percent and having a Mooney viscosity of 84 MU, measured at 121 C. Manufactured by Chemours FC LLC.

Comparative example FKM3: Viton® type F, copolymer of vinylidene fluoride (VDF), hexafluoropropylene (HFP) and tetrafluoroethylene (TFE), 36 wt % VDF, 70% F, −8° C. Tg. Manufactured by Chemours FC LLC.

Comparative example FKM4: Viton® type GFLT, copolymer of vinylidene fluoride (VDF), perfluoro(methyl vinyl ether) (PMVE) and tetrafluoroethylene (TFE), 36% VDF, 67% F, −23° C. Tg. Manufactured by Chemours FC LLC.

Comparative example PTFE1: tetrafluoroethylene homopolymer having a melt creep viscosity of 4.0×10¹¹ poise manufactured by Chemours FC LLC.

Example PTFE1+5% PFA1: cocoagulated composition containing 95 wt % PTFE1 and 5 wt % PFA1 manufactured by the present cocoagulation method.

Example PTFE1+10% PFA1: cocoagulated composition containing 95 wt % PTFE1 and 10 wt % PFA1 manufactured by the present cocoagulation method.

Comparative example PTFE2: modified tetrafluoroethylene polymer, containing 0.018 wt % of copolymerized PFBE (perfluorobutyl ethylene) and 0.016 wt % HFP (hexafluoropropylene) modifiers, having a melt creep viscosity of 1.5×10¹¹ poise manufactured by Chemours FC LLC.

Example PTFE2+5% PFA1: cocoagulated composition containing 95 wt % PTFE2 and 5 wt % PFA1 manufactured by the present cocoagulation method.

Example PTFE2+10% PFA1: cocoagulated composition containing 95 wt % PTFE2 and 5 wt % PFA1 manufactured by the present cocoagulation method.

Example PTFE2+5% FKM2: cocoagulated composition containing 95 wt % PTFE2 and 5 wt % FKM2 manufactured by the present cocoagulation method.

Comparative example PTFE3: modified tetrafluoroethylene polymer, containing 0.128 wt % of copolymerized PPVE (perfluoro (propyl vinyl ether)) as modifier, having a melt creep viscosity of 1.47×10¹⁰ poise, manufactured by Chemours FC LLC.

Example PTFE3+5% PFA1: cocoagulated composition containing 95 wt % PTFE3 and 5 wt % PFA1 manufactured by the present cocoagulation method.

Example PTFE3+10% PFA1: cocoagulated composition containing 95 wt % PTFE3 and 10 wt % PFA1 manufactured by the present cocoagulation method.

Example PTFE3+5% FKM1: cocoagulated product containing 95 wt % PTFE3 and 5 wt % FKM1 manufactured by the present cocoagulation method.

Comparative example PTFE4: modified tetrafluoroethylene polymer, containing 0.038 wt % of copolymerized PFBE (perfluorobutyl ethylene) as modifier, having a melt creep viscosity of 9.16×10¹⁰ poise manufactured by Chemours FC LLC.

In the present document and appended figures Example may be abbreviated as “Ex.” and Comparative Example may be abbreviated as “CEx.”.

### Cocoagulation Method to Manufacture Present Fluoropolymer Compositions

The following are examples of the present cocoagulation method to make two present fluoropolymer compositions. The cocoagulation method described here was followed to produce the present fluoropolymer compositions described in the present Examples.

### Manufacture of Example PTFE2+5% PFA1 Fluoropolymer Composition

To a 3-liter glass vessel equipped with four stainless steel baffles was added 823 mL of demineralized water, 946 mL of a CEx. PTFE2 aqueous dispersion with a polymer solids of 34.63%, 88 mL of a CEx. PFA1 aqueous dispersion with a polymer solids of 21.47%, and 43 mL of a 20% ammonium carbonate solution. A mechanical stirrer equipped with two 4-blade turbine agitators attached to a central shaft, was added to complete the apparatus. Dimensions of the full coagulator assembly are as follows. The 3 L glass container has an inner diameter of 13 cm. The baffles are attached with a thin metal ring and have a height of 13 cm and a width of 1.5 cm. The two agitators are separated by 6 cm on the shaft and comprised of four blades (blades are 1.5 cm wide and 4.5 cm long) with a 45-degree pitch. The rotation is in the direction to create an upward flow of fluid. With the lid in place (through which the agitator shaft runs), the contents of the coagulator were stirred at 800 rpm with a Caframo BDC3030 motor until the solid co-coagulated polymer was sufficiently separated from the water. After decanting, the wet powder was washed with 1000 mL of demineralized water then filtered through cheesecloth. The powder was dried at a temperature of 150 C in a tray oven to yield the co-coagulated Ex. PTFE2+5% PFA1 fluoropolymer composition with a DSC first melting point of 341.5 degrees C.

### Manufacture of Example PTFE3+5% FKM1 Fluoropolymer Composition

The Ex. PTFE3+5% FKM1 fluoropolymer composition with a DSC first melting point of 338.48 degrees C. was prepared according to the procedure for the manufacture of Ex. PTFE2+5% PFA1 offered earlier herein, using 74 mL of demineralized water, 1643 mL of a CEx. PTFE3 aqueous dispersion with a polymer solids of 34.63%, and 140 mL of an CEx. FKM1 aqueous dispersion with a polymer solids of 11.92%.

### Test Methods

Polymer Solids-Polymer solids of the fluoropolymer dispersions were measured gravimetrically by evaporating a tared mass of dispersion to dryness using a Mettler Toledo HX204 moisture analyzer.

Melting Point-Differential Scanning calorimetry first melting point was measured using a TA Instruments Q2000 instrument operating at a ramp rate of 2 degrees per minute and Universal Analysis 2000 software version 4.5A.

### Test Method: Solid Aerosol Particle Size Characterization Using Variable Shear Air Jets

A Microtrac MRB S3500 Particle Size Analyzer was used to characterize the particle size and friability (grindability) of present fluoropolymer composition powders under varying levels of dispersion energy from pressurized air jets. This instrument measures particle size distribution by laser diffraction, and offers a quantitative assessment of the friability of the present fluoropolymer compositions as compared with the pure tetrafluoroethylene polymers.

The key instrument operational settings for these experiments included: Dry Feeder TurboTrac: 95 PSI dried air; 0-60 PSI air to eductor (0-75 LPM); high shear eductor -gap setting 1; 4-6 in H₂O vacuum (≈50 LPM) (Nilfisk GM-80); temperature 22C; and relative humidity 40-55%.

The key calculation parameters for these experiments included: particle refractive index: 1.35; particle shape: irregular; and particle transparency: transparent.

The procedure for the experiments using this instrument included: 1) Samples stored under refrigeration (4deg C) until ready for measurement; 2) set desired pressure on instrument; 3) gently scoop 250 mg-500 mg fluoropolymer composition onto weigh paper using a spatula. Then pour the sample onto sampling tray.; 4) load sampling tray into the “Turbotrac” and perform measurement through device computer software.

Procedural notes for the experiments using this instrument: 1) 250 mg up to 500 mg of fluoropolymer composition is measured depending on pressure and flow rate used and sample behavior. Too much fluoropolymer composition powder can clog the eductor system or produce erroneous results from high particle concentration effects. Too little powder will not give sufficient detection signal and give poor results.; 2) Powder may buildup in the eductor, especially when measuring powders of small particle size at high air flowrates. The powder buildup will need to be cleaned as powder flow will be stopped.; 3) The air pressure supplied to the eductor is varied to adjust the level of dispersive energy/shear to the fluoropolymer composition particles. High pressures results in more particle breakage, producing smaller particle sizes. A volumetric flow meter was added to measure the air flow rate into the eductor. A pressure of 0 psi means there is no pressured air fed into the eductor, so the powder flows under vacuum flow.; 4) A secondary air regulator was added inline with the eductor air feed for the 2.3 psi pressure.

Eductor Air Flow Rate at given pressure:

| Pressure (PSI) | Air Flow (LPM) |
|---|---|
| 60 | 75 ± 1 |
| 40 | 59 ± 1 |
| 20 | 35 ± 1 |
| 10 | 20 ± 1 |
| 2.3 | 11 ± 1 (with added inline regulator) |
| 0 | 0 |

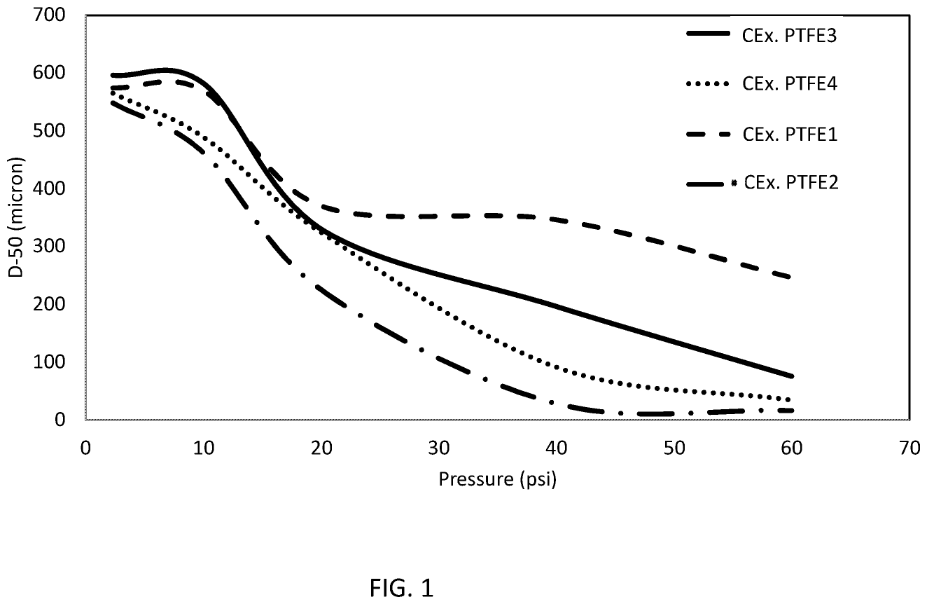

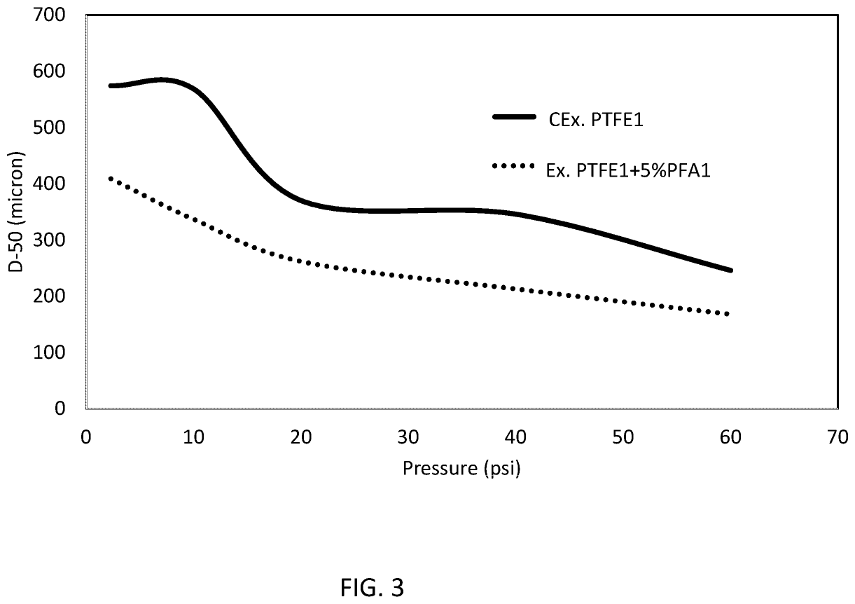

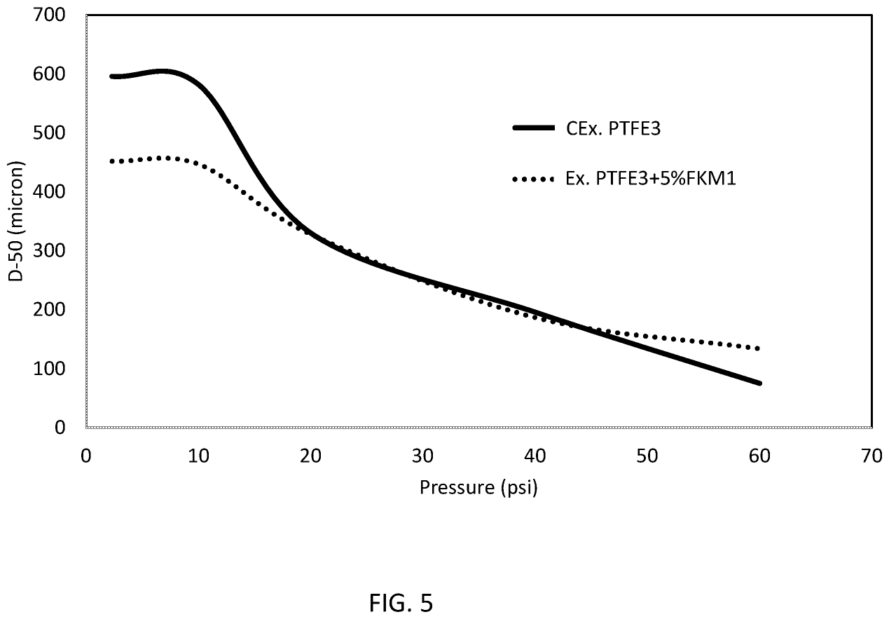

The results are shown in the Table below, and in FIGS. 1-5.

| | Pressure (psi) | | | | |
|---|---|---|---|---|---|
| Sample | 2.3 | 10 | 20 | 40 | 60 |
| CEx. PTFE1 | 574 | 569 | 370 | 346 | 246 |
| Ex. PTFE1 + 5% PFA1 | 409 | 337 | 262 | 213 | 168 |
| Ex. PTFE1 + 10% PFA1 | 374 | 333 | 256 | 204 | 103 |
| CEx. PTFE2 | 548 | 462 | 225 | 28 | 16 |
| Ex. PTFE2 + 5% PFA1 | 258 | 215 | 89 | 28 | 16 |
| Ex. PTFE2 + 10% PFA1 | 242 | 209 | 44 | 17 | 10 |
| CEx. PTFE3 | 596 | 582 | 330 | 196 | 75 |
| Ex. PTFE3 + 5% PFA | 377 | 330 | 256 | 172 | 29 |
| Ex. PTFE3 + 10% PFA1 | 317 | 280 | 194 | 46 | 22 |
| Ex. PTFE3 + 5% FKM1 | 452 | 447 | 328 | 187 | 134 |
| CEx. PTFE4 | 565 | 489 | 324 | 91 | 34 |
| Ex. PTFE4 + 5% PFA1 | 347 | 324 | 225 | 38 | 22 |
| Ex. PTFE4 + 10% PFA1 | 385 | 334 | 232 | 52 | 18 |

### Discussion of Results for Test Method: Solid Aerosol Particle Size Characterization Using Variable Shear Air Jets

As discussed earlier herein, as polymerized tetrafluoroethylene polymer primary particles typically have sub-micron size range. These primary particles agglomerate to form larger agglomerates or aggregates that have a sizes ranging between 400-600 microns. During the present particle size analysis test, the agglomerated powders are subjected to varying levels of energy via a pressurized air jet. Increasing the energy level leads to greater reduction in measured agglomerate sizes, a quantitative assessment of the friability of the fluoropolymer composition agglomerates. As shown in FIG. 1, all conventional tetrafluoroethylene polymers powders show some reduction in agglomerate sizes as the energy levels increase. Different tetrafluoroethylene polymer agglomerate powders though show differences in the levels of agglomerate size reduction (friability), especially at higher energy levels.

The present inventors surprisingly discovered that particle size reduction without substantial fibrillation of the tetrafluoroethylene polymers is greatly increased for the present cocoagulated dry friable agglomerates comprising: i.) a first polymer comprising a tetrafluoroethylene polymer having a melt creep viscosity of at least about 0.5×10¹¹ poise, and; ii.) a second polymer different from said first polymer.

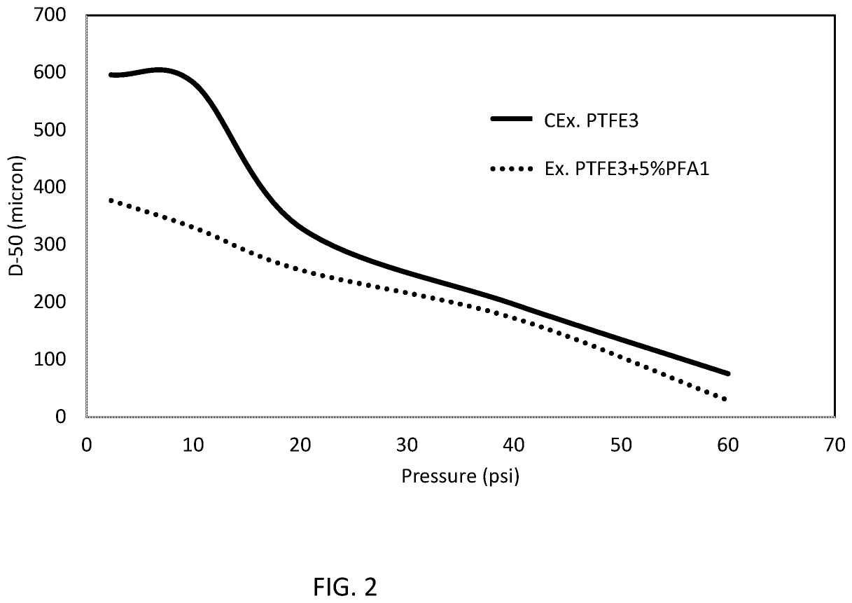

This effect can be appreciated from examination of the experimental data in the previous Table and FIGS. 2-5. These examples show that even at low energy levels (10 psi and lower), the fluoropolymer composition agglomerate size is substantially lower with the co-coagulated product than with the pure tetrafluoroethylene polymer powder used to generate the co-coagulated product.

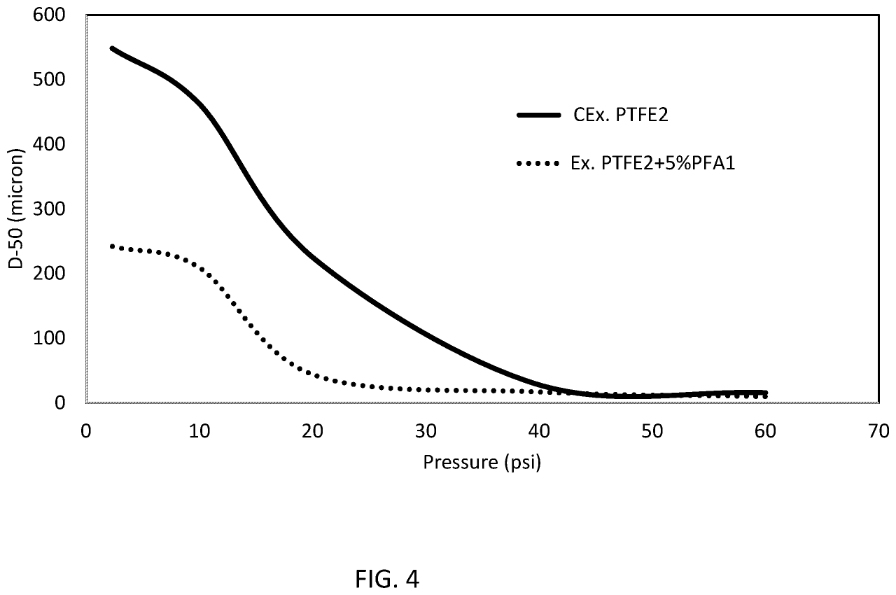

Referring to FIG. 4 for example, at low energy levels, the base CEx. PTFE2 has an agglomerate size of 548 microns. When CEx. PTFE2 is co-coagulated with another fluoropolymer (5 wt % CEx. PFA1) the agglomerate size for the co-coagulated product Ex. PTFE2+5% PFA1 is reduced to 258 microns.

### Comparison of Chemical Cocoagulation Versus Mechanical Cocoagulation on Friability of Agglomerates

Cocoagulation of a CEx. PTFE3 and 5% CEx. PFA1 aqueous dispersion mixture was carried out by a procedure substantially identical to that earlier described for the Manufacture of the Ex. PTFE2+5% PFA1 Fluoropolymer Composition, using ammonium carbonate solution combined with mechanical stirring (Chemical Cocoagulation). An identical procedure was carried out, however no ammonium carbonate solution was added, only mechanical stirring was used to cocoagulate the mixture (Mechanical Cocoagulation).

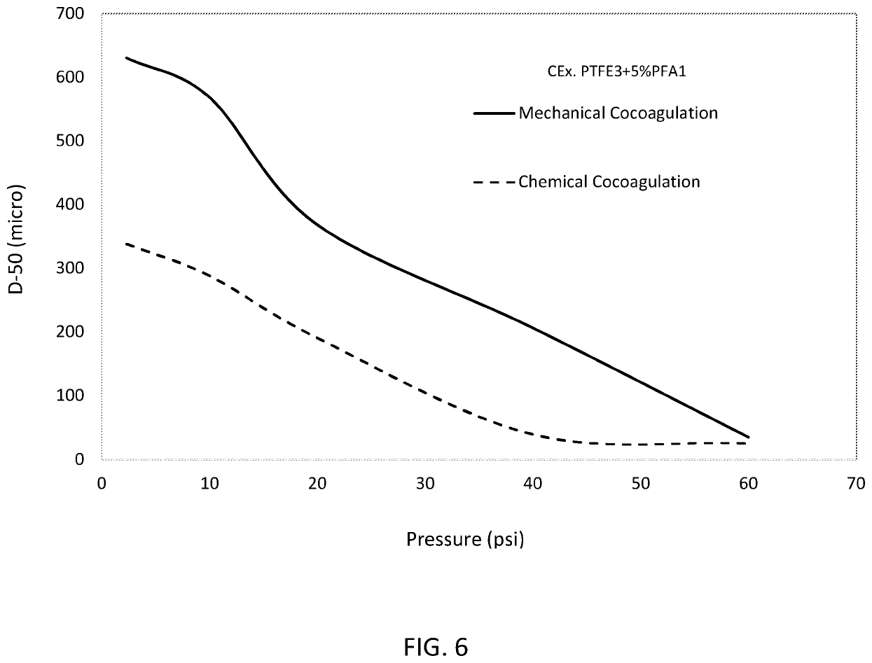

The resultant agglomerated powders were then subjected to varying levels of energy via a pressurized air jet using the earlier described TEST METHOD: SOLID AEROSOL PARTICLE SIZE CHARACTERIZATION USING VARIABLE SHEAR AIR JETS. The results are shown in the table below and FIG. 6.

Comparison of Chemical Cocoagulation versus Mechanical Cocoagulation

| | Particle Size by | Particle Size by |
|---|---|---|
| | Mechanical | Chemical |
| Pressure | Cocoagulation | Cocoagulation |
| (PSI) | (D-50 (micron) | (D-50 (micron)) |
| 0 | 643.5 | 354.1 |
| 2.3 | 630.2 | 338.4 |
| 10 | 568.2 | 288.3 |
| 20 | 368.3 | 190.8 |
| 40 | 206.8 | 39.35 |
| 60 | 35.25 | 25.17 |

The results surprisingly show that smaller and more friable agglomerates are obtained using chemical cocoagulation as compared to mechanical cocoagulation alone.

### Cathode

Test cathodes were prepared using the present fluoropolymer compositions by the following procedures:

Mixing: A cathode active material (lithiated transition metal oxides) and conductive carbon were mixed using mortar/pestle for 15 minutes. A present fluoropolymer composition fluoropolymer binder was added and loosely mixed into the CAM/conductive carbon powder mixture. The three electrode components are then mixed using a roll mill with 1 10 mm ceramic bead/gram of electrode mixture in a 125 ml HDPE bottle at a speed of 90 rotations per minute for 30 minutes. The total weight of the batch is 10 g.

Electrode (Cathode) Formation: The cathode electrode mixture (3g) was placed onto a hot plate heated to 100° C. and rolled out by hand using a steel roller heated to 100° C. Once an initial film formed, the film was folded over on itself and rolled out again to increase the strength of the film. This process is repeated until a 300 μm thick free-standing cathode film was produced. This free-standing cathode film was then placed in a folded piece of 50 μm thick aluminum shim. The cathode film and shim were passed through vertically fed calendering rolls to reduce the thickness. The gap distance of the rolls started at 350-450 μm and was gradually lowered 50 μm at a time until 200 μm where it is then lowered to 180, 150, and finally 130 μm. As the gap decreased below 200 μm, the number of passes through the gap increased. The film was calendered until it reached 70-90 μm thick. The cathodes are high loading, ˜30 mg/cm².

Sample Composition: Cathodes were prepared containing LiNi_{0.6}Mn_{0.2}Co_{0.202} (NMC622), Super P, and present fluoropolymer composition in a 90:5:5 weight % ratio. Half cells were cycled under the assumption that NMC622 has a practical capacity of 190 mAh/g.

Half Cell Configuration: The cathodes (15 mm) were cycled free-standing. Li metal was used as the anode (15.6 mm). A Celgard separator (19 mm) was used. The half cell was assembled a CR2032 coin cell (20 mm). 30 μL of electrolyte solution was added to the coin cells (EC/EMC v/v 50:50 1M LiPF₆). Commercial NMC622 cathodes using PVDF wet slurry were purchased for comparison.

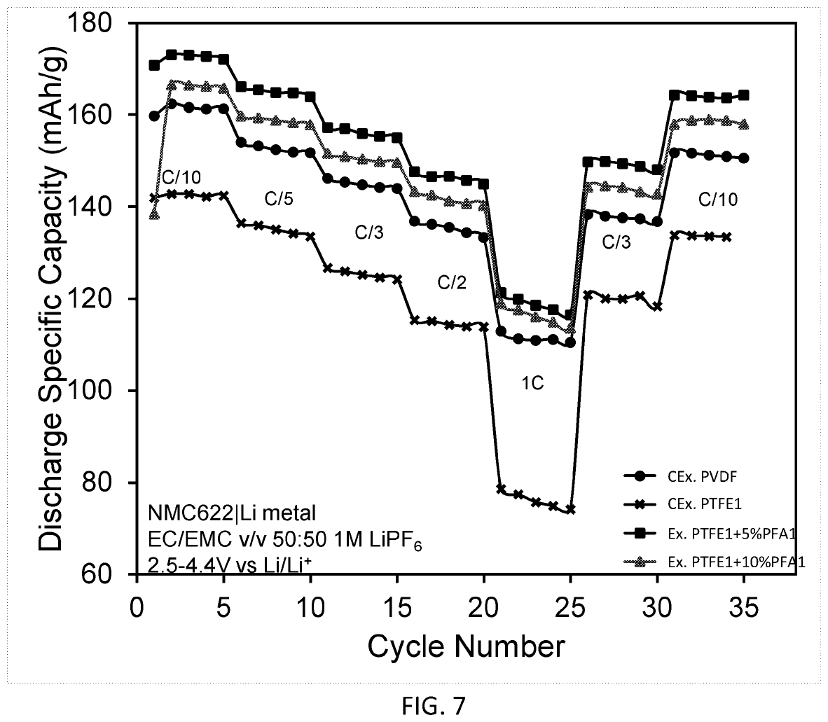

Equipment: The coin cells were cycled using a Neware battery tester. FIGS. 7, 8 and 9 are rate capability tests for half cells including NMC622, Super P, and a specified fluoropolymer binder. Rate capability tests illustrate how well Li+ diffuse within a battery electrodes at various rates of charge/discharge. 1C=1 hour charge/discharge All of the cells were cycled from 2.5-4.2 V versus Li/Li+at room temperature.

Quantifications: Capacity retention values were calculated by specific capacity/initial specific capacity×100=% capacity remaining after x# of cycles.

### Discussion of Cathode Experimental Results:

The present data exhibited in FIG. 7 shows that the relatively high molecular weight (melt creep viscosity) tetrafluoroethylene homopolymer CEx. PTFE1 tends to have decreased performance, especially at cycling rate of 1C. With the addition of PFA (CEx. PFA1) to the CEx. PTFE1 structure by the present cocoagulation method. there is comparable performance of the high-loading cathodes with low loading PVDF wet slurry commercial cathodes. The present inventors believe that this is a surprising and significant result, suggesting that the present fluoropolymer compositions can generate higher-loading cathode structures, with reversible capacity retention. Additionally, examples Ex. PTFE1+5% PFA1 and Ex. PTFE1+10% PFA1 have higher discharge capacities after the initial formation cycle in comparison to a conventional PVDF wet slurry electrode.

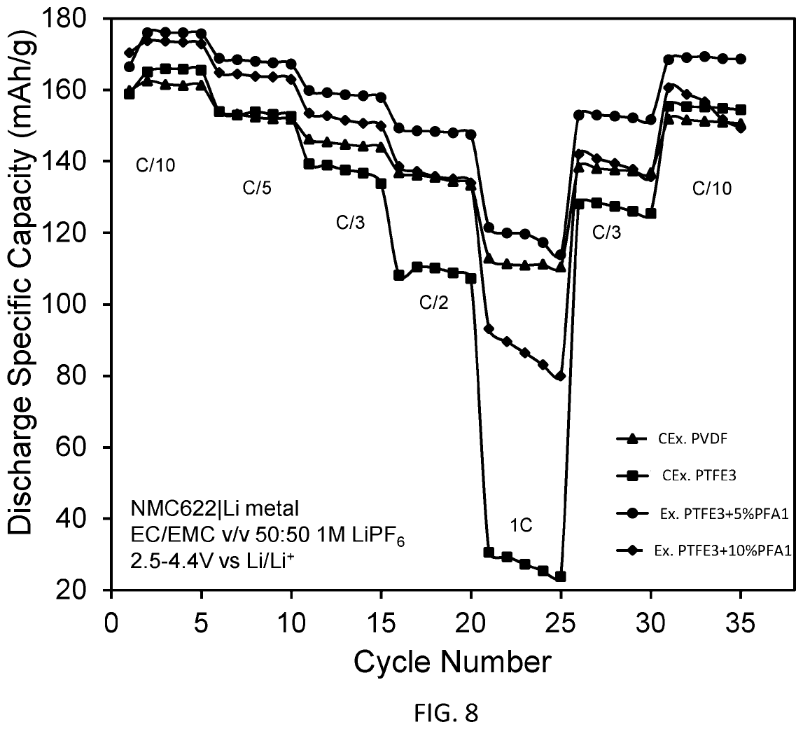

The present data exhibited in FIG. 8 shows that CEx. PTFE3 has poor performance at high cycling rates, but upon cocoagulation with PFA1 by the present method, the resultant example Ex. PTFE3+5% PFA1 has ˜100 mAh/g increase at 1C. Example Ex. PTFE3+5% PFA1 has a reversible specific capacity under rate capability testing that illustrates performance superior to the comparative PVDF wet slurry low loading electrodes.

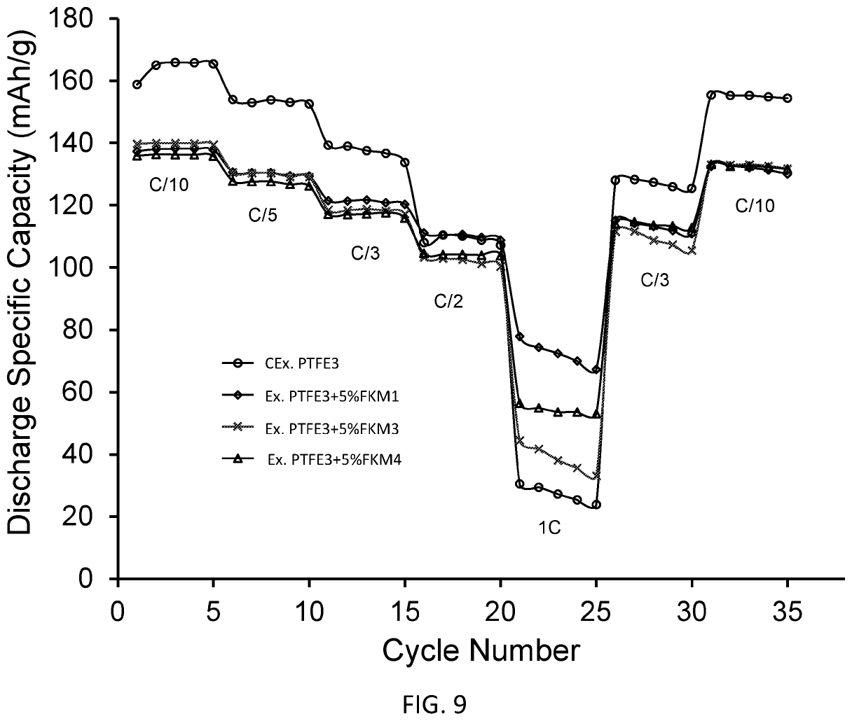

FIG. 9 shows discharge specific capacity (mAh/g) versus cycle number for CEx. PTFE3, Ex. PTFE3+5% FKM1, Ex. PTFE3+5% FKM3 and Ex. PTFE3+5% FKM4. The data exhibited in FIG. 9 shows that CEx. PTFE3 has a higher discharge specific capacity at C rates below C/2. Upon increasing the C-rate, the cocoagulated binders are believed to result in improved electrode microstructure, causing the discharge specific capacity to be increased. The PTFE-FKM materials have comparable discharge specific capacity at C rates below C/2. Without wishing to be bound by theory, it is believed that the differences in molecular architecture of the PTFE-FKM materials leads to positive variations in processing properties (i.e., mixing homogeneity) and performance metrics, uniquely illustrated at 1C. Further, the friable nature of the PTFE-FKM materials is believed to be advantageous, when processed optimally, to achieve higher rate performance for commercial battery applications that require high-loading cathodes (e.g., 30 mg/cm²).

### Anode

Test anodes were prepared using the present fluoropolymer compositions by the following procedures:

Mixing: 1. Weigh out material for a 10g batch with a composition of 90% Graphite, 5% Super P conductive carbon, and 5% PTFE (or present inventive fluoropolymer composition).; 2. Combine graphite and Super P in a mortar and pestle for 15 min.; 3. Add graphite and Super P mixture and the PTFE to a 250 mL plastic bottle with 10 beads (1 bead/g material).; 4. Set roll mill speed to 55 and place the bottle into the holder and tape the top closed. Put on roller for 30 minutes.; 4. After 30 minutes, remove the beads from the anode mixture and gently scrape any material stuck to the side of the bottle off.

Anode Film Formation: The anode electrode mixture (3g) was added to an 8 oz glass mortar and pestle and ground at room temperature until a flake is formed. This flake was placed on a hot plate heated to 100° C. and rolled out using a steel roller heated to 100° C. to create a stronger and more uniform initial film.

Calendering: This film was then calendered directly on calendering rolls heated to 50° C. to reduce the film thickness. The gap distance of the rolls starts at 300 μm and is gradually reduced 100 μm at a time until 100 μm where it is then reduced to 50 μm. The film was then passed through 2-10 times at each gap with the number of passes increasing as the gap is reduced. The film was so calendered until it reached a thickness of 70-90 μm.

Anode Lamination: 1. Cut a piece of copper foil, wipe both sides with IPA, and allow to dry.; 2. Pour copper etchant into a glass tray. Place one side of the copper foil into the etchant for 10 seconds.; 3. Transfer copper foil to another glass tray filled with DI water and soak for a minute. Thoroughly rinse the copper foil with DI water and dry on a blue napkin.; 4. When not in use, store etched copper in the dry box or it will oxidize if left out.; 5. Plasma treat etched copper.; 6. Heat a hot press to 300° C. Place the anode film onto the copper foil and in between two sheets of the metal shim. Place the metal shim onto steel backing plates.; 7. Press at 5,000 lbs. for 5 minutes.; 8 Take it off the hot press and allow to cool before removing the metal shims. The shims may stick slightly to the anode.

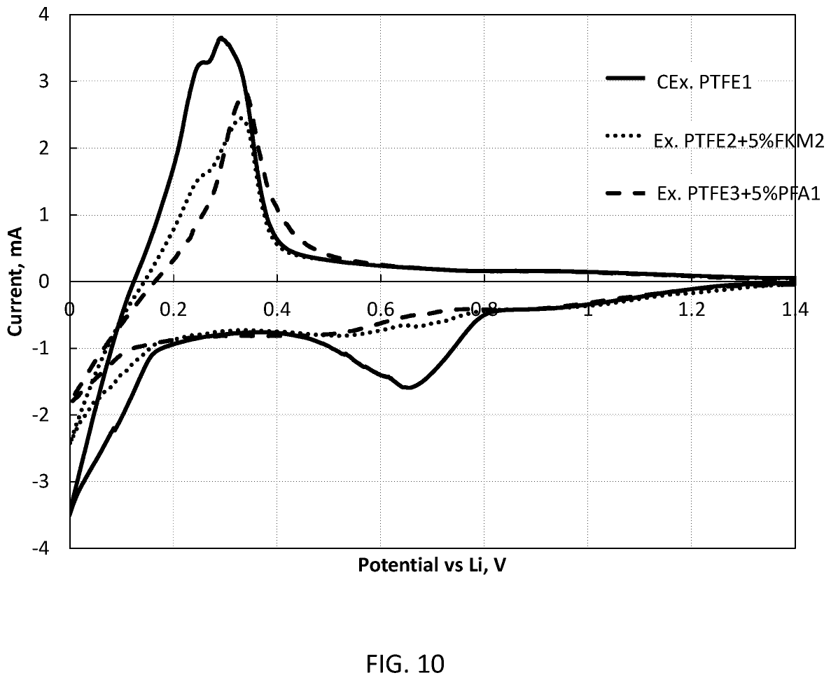

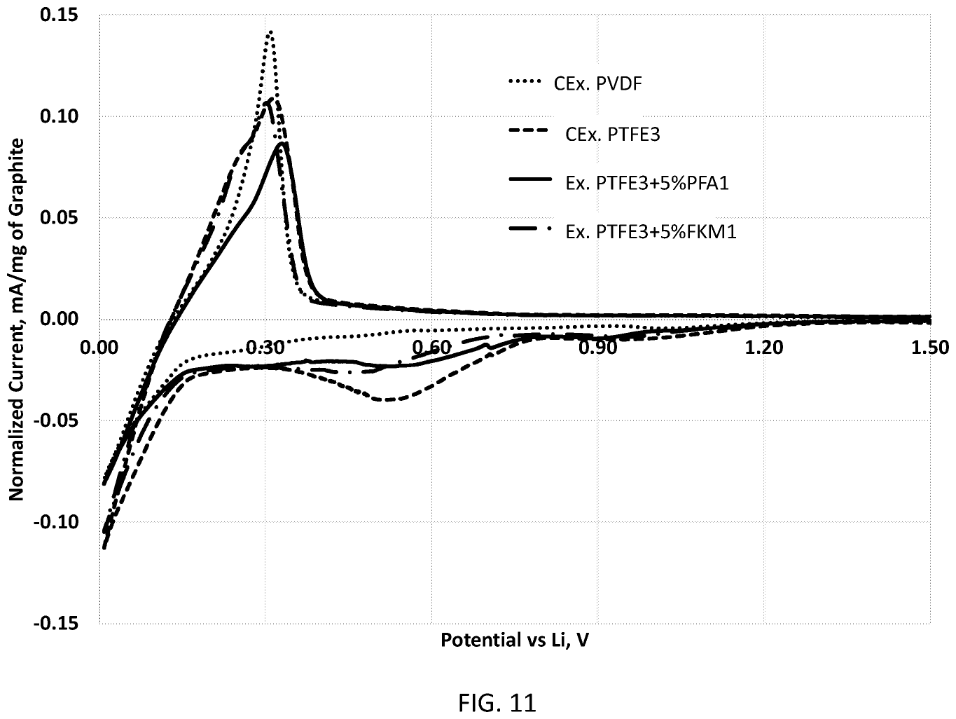

Cyclic Voltammetry Measurement: Electrode disks (15 mm in diameter) were punched and dried at 120 degree C. in vacuum oven overnight. Each electrode was utilized to assemble 2032 type coin cells with lithium metal counter electrode. Monolayer polypropylene Celgard film separator and 1.2 M LiPF₆ in EC/DEC (3:7 by volume) with 5% FEC additive electrolyte were used in the coin cells. The cyclic voltammetry was measured in a Bio-Logic Potentiostat. The cyclic voltammetry testing consists of scanning from 0 to 1.5 V potential versus Li-metal at 0.1 mV/sec scan rate. The 1st loop of the data obtained is plotted from 0 to 1.4 V which includes both oxidation and reduction peaks as shown in FIG. 10 and FIG. 11.

Cyclic voltammetry shows the oxidation and reduction features of the electrode components. The reduction signal between 0.9 to 0.3 V is assigned to the degradation of the tetrafluoroethylene polymer. The signal (reduction) around 0.1 V represents the graphite lithiation. The oxidation signal around 0.2 V represents the graphite delithiation. Tetrafluoroethylene polymer PTFE reduction is an irreversible process while graphite reduces and oxidizes reversibly when alternating from negative to positive current. Tetrafluoroethylene polymer PTFE reduction decreases the binding property of the tetrafluoroethylene polymer thereby leading to poor battery performance. In order to quantify the fluoropolymer reduction (or degradation), the integrated area under the X-axis can be calculated by multiplying voltage and normalized current and adding them in the voltage range of 0.9 and 0.3V. The percentage improvement or decrease in the degradation of the fluoropolymer in the anode composition can be calculated using the integrated current in the cyclic voltammetry test. The percent improvement or decrease in the degradation can be represented by 100×(1-(integrated current of example)/integrated current of comparative example)).

Without wishing to be bound by theory, the present inventors believe that the reduction peak between 0.3V to 0.9V is related to PTFE decomposition and formation of inactive LiF like compounds. PTFE decomposition degrades the PTFE's binding property which leads to poor electrode cohesion and adhesion thereby producing poor battery performance. Regarding FIG. 10, compared to CEx. PTFE1, both Ex. PTFE2+5% FKM2 and Ex. PTFE3+5% PFA1 binder samples showed lower decomposition/reduction current signifying FKM and PFA modified binder provides better battery electrode binding property compared to the corresponding pure PTFE. Regarding FIG. 11, compared to CEx. PTFE3, both Ex. PTFE3+5% FKM1 and Ex. PTFE3+5% PFA1 binder samples showed lower decomposition/reduction current signifying FKM and PFA modified binder provides better battery electrode binding property compared to pure PTFE.

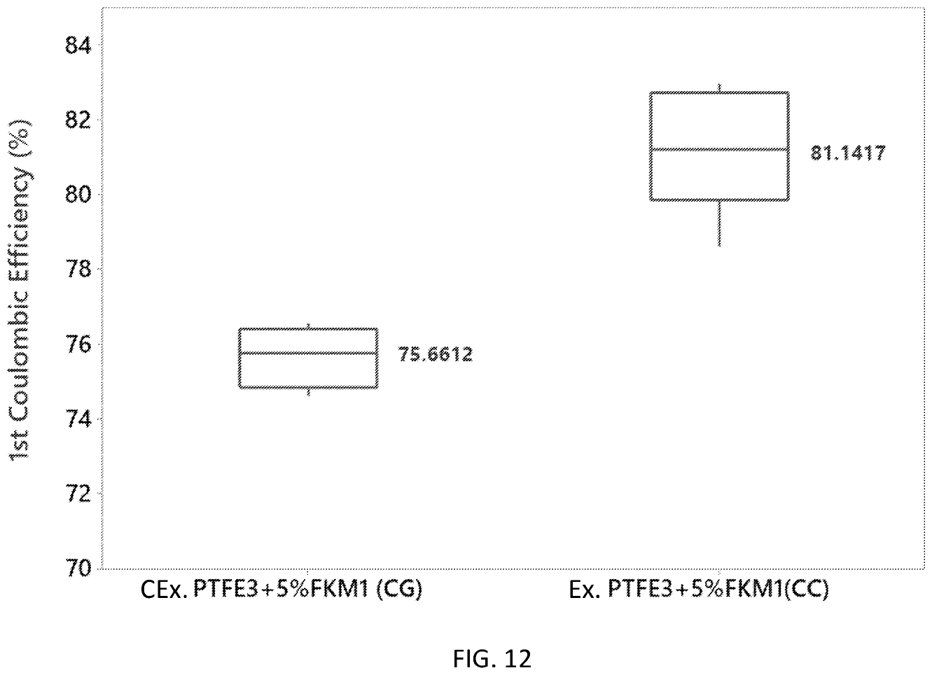

Regarding FIG. 12, the PTFE reduction in graphite anode in lithium-ion battery can also be measured in terms of 1st cycle coulombic efficiency of graphite anode half cells. The lower value of coulombic efficiency indicates higher PTFE reduction in the anode. The binder which provides higher coulombic efficiency of the graphite anode half-cell is due to less reduction of PTFE during lithium intercalation in graphite. Here are compared the coulombic efficiency of graphite anode fabricated with CEx. PTFE3+5% FKM1 (CG) equivalent binder composition but mixed by cryo-grinding (CG) rather than cocoagulation of aqueous dispersions, and Ex. PTFE3+FKM1 (CC) cocoagulated (CC) binder. Both of these anodes contain the same composition of 90:5:5 weight ratio of active graphite, SP Carbon, and present fluoropolymer binder. The notably higher value of the coulombic efficiency of anode fabricated with Ex.

PTFE3+5% FKM1 (CC) compared to the anode fabricated with the cryogrinding prepared binder CEx. PTFE3+FKM1 (CG) indicates that the PTFE binder obtained by cocoagulation is more electrochemically stable in the anodic voltage region compared to the PTFE binder sample obtained by a physical mixing process such as cryo-grinding.

### Cryo Grinding Comparative Procedure

A SPEX 6875 Freezer/Mill® high capacity cryogenic grinder (Cole-Parmer, Metuchen, NJ 08840) was used to prepare cryoground samples. Sample (5 grams) was put into a cryogrind tube containing a striker pin. The tube was placed into the cryogrind holder and the cryogrinder closed and locked. The cryogrinding settings were: 4 minute cool down followed by 10 minutes of cryogrinding. Then, after a 2 minute cool down, 10 minutes of further cryogrinding was repeated, resulting in the cryoground samples.

### Rate Performance of Anode Binders

Rate Capability tests illustrate how well Lit diffuses within a battery electrode at various rates of charge/discharge. 1C=1 hour charge/discharge. All the cells were cycled at room temperature.

For comparison, a slurry processed graphite electrode using conventional polyvinylidene fluoride (PVDF) binder was prepared. Desired amounts of SP Carbon and graphite active anode materials were mixed by mortar and pestle for 15 minutes, and then mixed using a roller mixer and zirconia milling balls (1 ball per gm of material) for additional 30 minutes. N-Methyl-2-pyrrolidone (NMP) and PVDF were mixed separately to obtain a thick solution. An amount of NMP/PVDF solution was added to the powder mixture and an additional amount of NMP was added to maintain a workable (e.g., pourable) viscosity slurry. The final mixture was mixed in a THINKY mixer at 2000 RPM for 2 minutes, for a total of three times, separate by a rest interval of a few minutes. A finely mixed viscous slurry was obtained. The slurry was manually cast on a copper foil current collector by utilizing a doctor blade. The wet lamination was transferred to a hot air furnace at 54° C. and maintained for at least 2 hours to obtain dry PVDF binder anode electrode sheet. Circular electrodes disks were punched and dried at 120° C. overnight before assembling the cells.

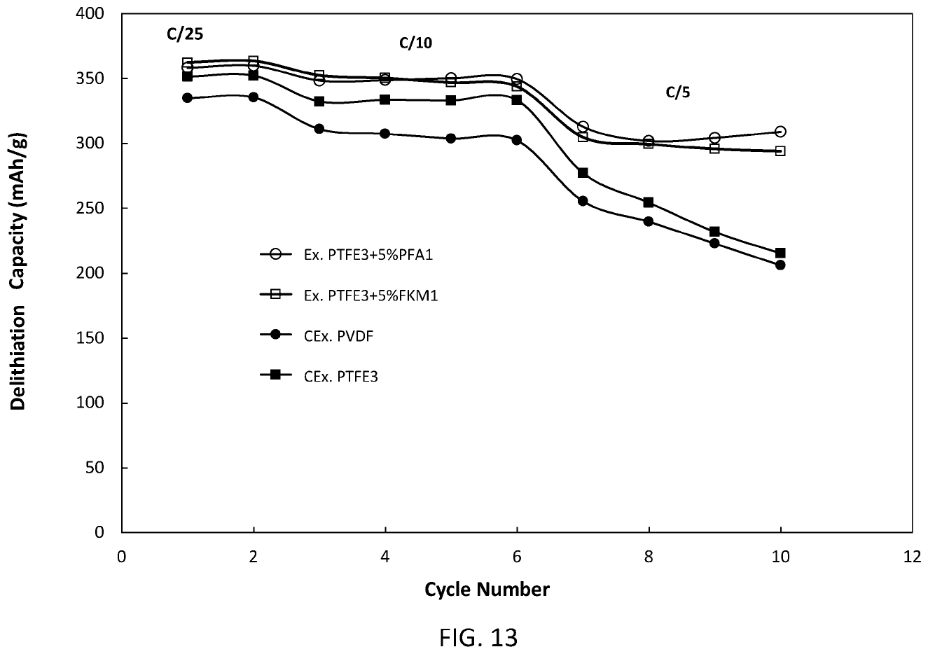

The data exhibited in FIG. 13 shows rate testing results of cocoagulated second polymers with polytetrafluoroethylene CEx. PTFE3 and CEx. PVDF wet slurry anodes as comparison. With addition of PFA (CEx. PFA1) to CEx. PTFE3 and FKM (CEx. FKM1) to CEx. PTFE3 structure by the present cocoagulation method, the resulting inventive cocoagulated fluoropolymer binders Ex. PTFE3+5% PFA1 and Ex. PTFE3+5% FKM1 exhibited improved rate performance, especially at cycling rate of C/5. Additionally, examples of Ex. PTFE3+5% PFA1 and Ex. PTFE3+5% FKM1 have higher capacities in comparison to polytetrafluoroethylene homopolymer CEx. PTFE3 and CEx. PVDF wet slurry electrodes. The present inventors believe that this is a surprising and significant result, suggesting the present fluoropolymer binder compositions enable higher-loading anode structures with reversible capacity retention.

### SEM Image Sample Preparation and Interpretation:

Electrode preparation: 10 g electrode material (85% PTFE and 15% Super P conductive carbon) was placed into a 250 mL plastic bottle with 10 beads. The PTFEs used were CEx. PTFE1 and Ex. PTFE3+5% PFA1. The mixture was ball milled for 30 minutes at roll mill speed of 55 rpm. A 3 g amount of the mixture was calendered into the film through the hot calender rolls (50° C.) (TMAXCN vertical calender machine) with resulting thickness between 200-250 μm.

Cell preparation/test, and electrode preparation: The free-standing electrode disks (15 mm in diameter) were punched and dried at 120° C. under vacuum at least 8 hours. 2032 type coin cells were assembled with lithium metal counter electrode, Celgard 2400 separator and 1.0 M LiPF₆ in EC/EMC (1:1 by volume, Gotion) electrolyte. The coin cells were cycled on Neware cell tester with constant current C/25 from 0.01V - 1.25V for 2 cycles. The finished cells were opened with TMAX coin cell de-crimper in N₂ glove bag. Cycled electrodes were collected for SEM investigation. The SEM images on fresh and cycled electrodes were taken from top with Zeiss Auriga 60 CrossBeam (FE-SEM).

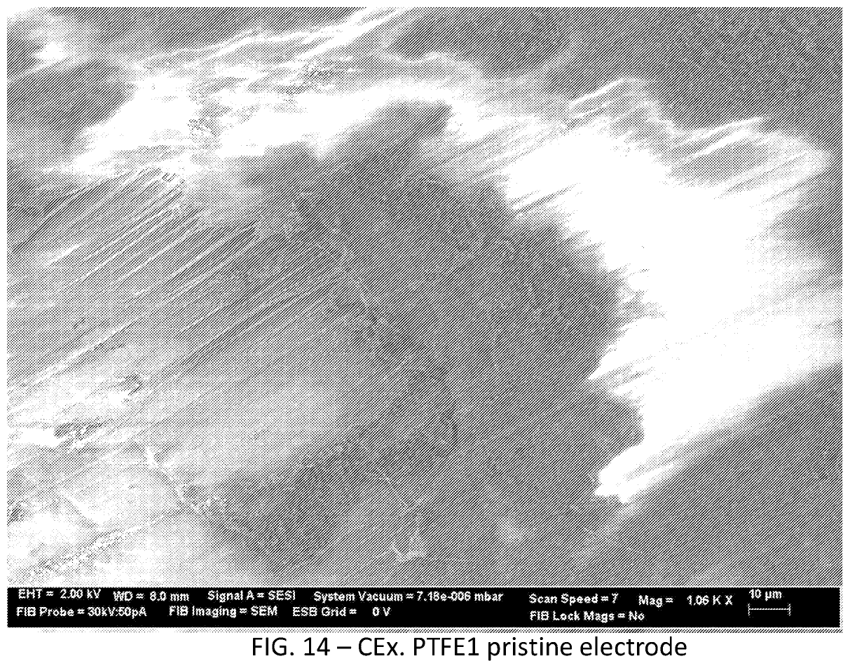

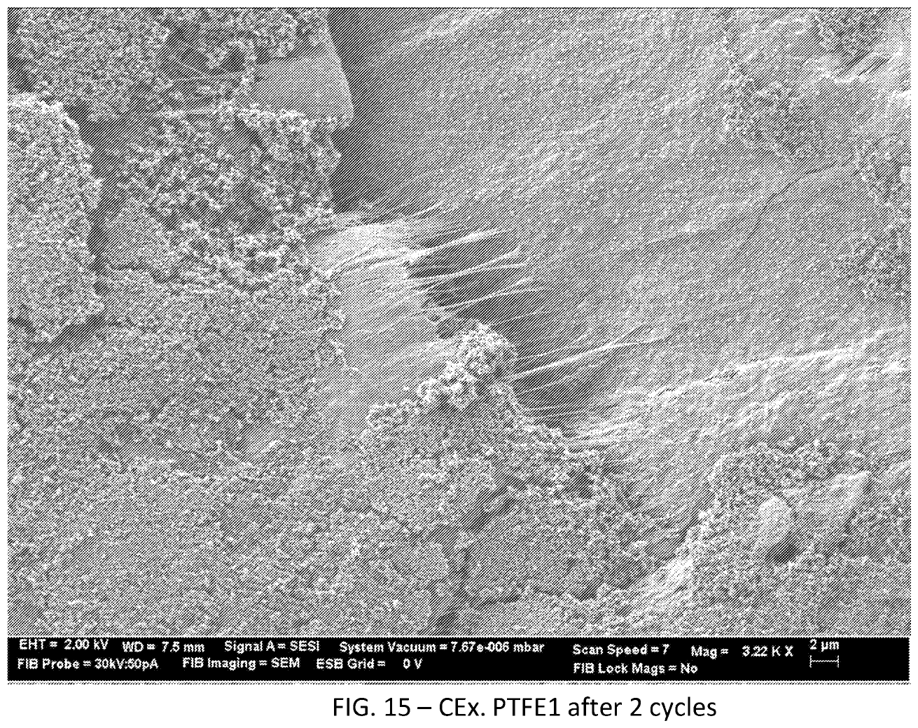

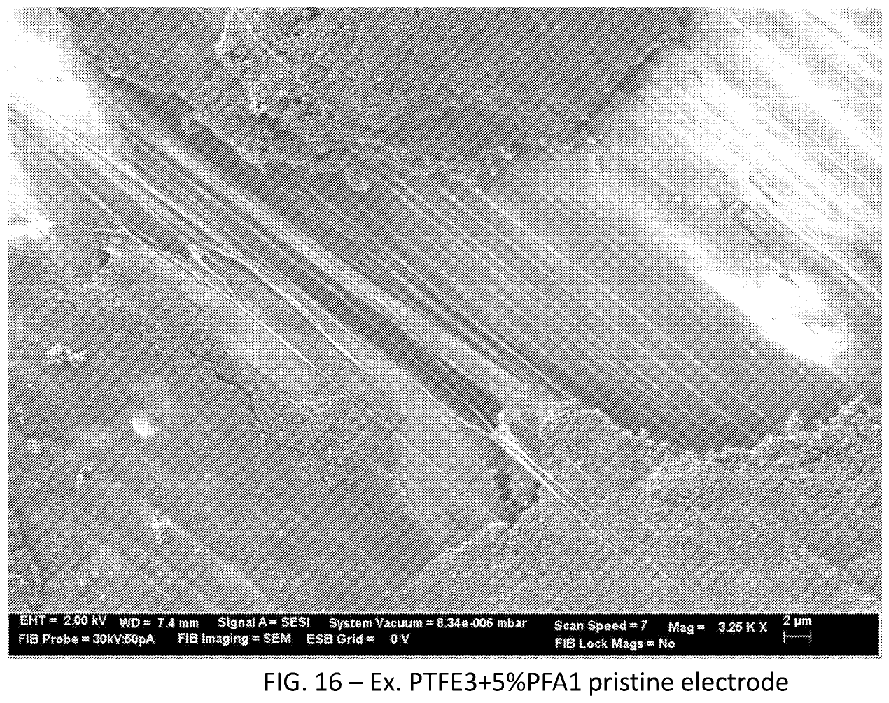

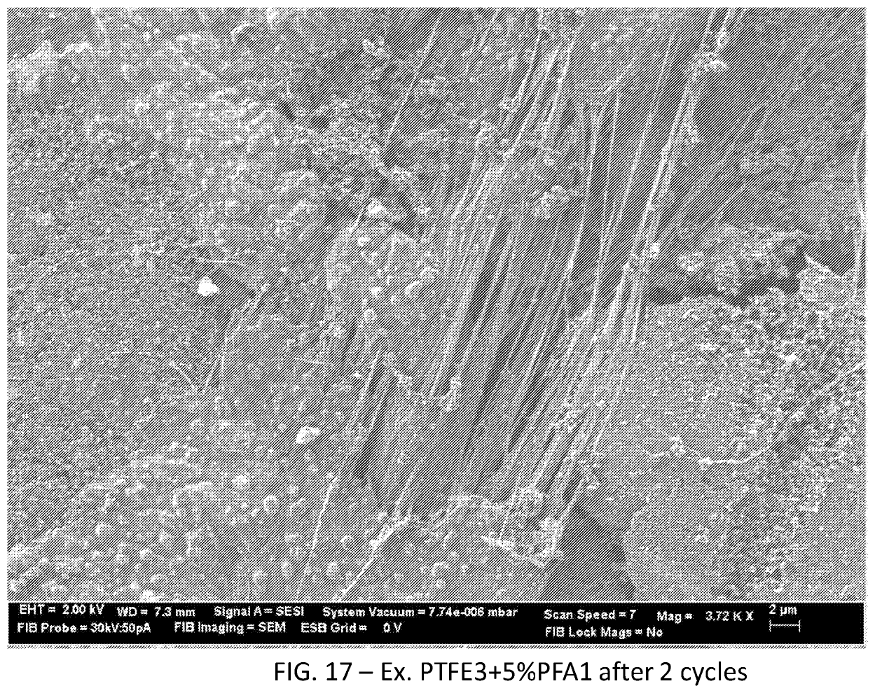

Discussion of anode experimental results: SEM photos in FIGS. 14-17 are of electrodes before and after 2 charge-discharge cycles, and are direct evidence of the PTFE fibrils stability against reduction. Long PTFE fibrils are observed for both CEx. PTFE1 and Ex. PTFE3+5% PFA1 pristine electrodes (see FIGS. 14 and 16). The length of PTFE fibrils of pristine CEx. PTFE1 is between 30 to 50 μm. After 2 cycles, the fibrils are degraded to 4-8 μm (see FIG. 15). The degradation of fibrils will deteriorate the binding force of PTFE and cause the mechanical failure of an electrode. On the contrary, the length of fibrils of pristine Ex. PTFE3+5% PFA1 (30-40 μm) (see FIG. 16) is still retained after 2 cycles (see FIG. 17), indicating that Ex. PTFE3+5% PFA1 is much more stable against reduction, which is a critical property to maintain the adhesion and cohesion for electrode as an anode binder. In summary, by comparing electrode SEM images before and after cycles, Ex. PTFE3+5% PFA1 is significantly more stable than CEx. PTFE1 (non-modified PTFE) in terms of reduction under conditions encountered in an anode of a lithium ion secondary battery.

1-158. (canceled)

159. A fluoropolymer composition for use as binder in a lithium-ion secondary battery electrode, comprising dry friable agglomerates comprising: i.) a first polymer comprising a tetrafluoroethylene polymer having a melt creep viscosity of at least about 0.5×10¹¹ poise, and; ii.) a second polymer different from said first polymer.

160. The composition of claim 159, wherein said dry friable agglomerates are cocoagulated agglomerates comprising particles of said first polymer and said second polymer.

161. The composition of claim 159, wherein said agglomerates are comprised of substantially unfibrillated tetrafluoroethylene polymer and said agglomerates have an average particle size of from about 10 to about 300 micrometers.

162. The composition of claim 159, wherein the weight ratio of said tetrafluoroethylene polymer to said second polymer is from about 99:1 to about 80:20.

163. The composition of claim 159, wherein said agglomerates have an average particle size of from about 200 to about 1000 micrometers.

164. The composition of claim 159, wherein said tetrafluoroethylene polymer is a tetrafluoroethylene homopolymer consisting essentially of tetrafluoroethylene monomer repeating units or a modified tetrafluoroethylene polymer comprising tetrafluoroethylene monomer repeating units and about 1 weight percent or less modifying comonomer (modifier) repeating units.

165. The composition of any one of the preceding claims, wherein said tetrafluoroethylene polymer is substantially unfibrillated.

166. A composition for use in a lithium-ion secondary battery cathode film, comprising: i.) cathode active particles comprising lithium transition metal oxide; ii.) conductive carbon; and iii.) fluoropolymer binder comprising a mixture of particles of tetrafluoroethylene polymer having a melt creep viscosity of at least about 0.5×10¹¹ poise, and a second polymer; wherein said tetrafluoroethylene polymer is fibrillated.

167. The composition of claim 166, wherein said composition contains from about 1 to about 10 weight percent fluoropolymer binder, from about 95 to about 98 weight percent cathode active particles, and from about 1 to about 10 weight percent conductive carbon, based on the combined weight of said fluoropolymer binder, said cathode active particles, and said conductive carbon.

168. A composition for use in a lithium-ion secondary battery anode film, comprising: i.) anode active particles; and iii.) fluoropolymer binder comprising a mixture of particles of tetrafluoroethylene polymer having a melt creep viscosity of at least about 0.5×10¹¹ poise, and a second polymer; wherein said tetrafluoroethylene polymer is fibrillated.

169. The composition of claim 168, wherein said composition contains from about 1 to about 10 weight percent fluoropolymer binder, from about 90 to about 99 weight percent anode active particles.

170. A lithium-ion secondary battery comprising:
1. a cathode comprising: a cathode electrode layer adhered to a metal current collector, said cathode electrode layer comprising a cathode electrode composition comprising: a) cathode active particles comprising lithium transition metal oxide; b) conductive carbon; and c) fluoropolymer binder comprising a mixture of: i) particles of tetrafluoroethylene polymer having a melt creep viscosity of at least about 0.5×10¹¹ poise; and ii) particles of a second polymer;
2. an anode;
3. a separator between said cathode and said anode; and
4. an electrolyte in communication with said cathode, anode and separator.

171. The battery of claim 170, wherein said battery has a higher discharge specific capacity at a given C rate for C rates greater than or equal to C/2, than an identical battery wherein said fluoropolymer binder contains no said second polymer.

172. The battery of claim 170, wherein said composition contains from about 1 to about 10 weight percent fluoropolymer binder, from about 95 to about 98 weight percent cathode active particles, and from about 1 to about 10 weight percent conductive carbon, based on the combined weight of said fluoropolymer binder, said cathode active particles, and said conductive carbon.

173. The battery of claim 170, wherein: said tetrafluoroethylene polymer is selected from the group consisting of A) tetrafluoroethylene homopolymer consisting essentially of tetrafluoroethylene monomer repeating units, and B) modified tetrafluoroethylene polymer consisting essentially of tetrafluoroethylene monomer repeating units and about 1 weight percent or less modifying perfluoro (alkyl vinyl ether) comonomer repeating units, and wherein said second polymer comprises tetrafluoroethylene perfluoro (alkyl vinyl ether) polymer.

174. A lithium-ion secondary battery comprising:
1. an anode comprising: an anode electrode layer adhered to a metal current collector, said anode electrode layer comprising an anode electrode composition comprising: a) anode active particles; and b) fluoropolymer binder comprising a mixture of: i) particles of tetrafluoroethylene polymer having melt creep viscosity of at least about 0.5×10¹¹ poise; and ii) particles of second polymer;
2. a cathode;
3. a separator between said cathode and said anode; and
4. an electrolyte in communication with said cathode, anode and separator.

175. The battery of claim 174, wherein said battery has a higher delithiation capacity (mAh/g) at a given C rate than an identical battery wherein said fluoropolymer binder contains no said second polymer.

176. The battery of claim 174, wherein said anode exhibits by cyclic voltammetry measurement an electrochemical reduction between 0.25 V and 0.9 V versus Li/Li+ that is decreased relative to an anode in an identical battery wherein said fluoropolymer binder contains no said second polymer.

177. The composition or the battery of any one of claim 157, 166, 168, 170 or 174, wherein said second polymer is selected from the group consisting of: tetrafluoroethylene polymers having a melt creep viscosity different from that of said first polymer, tetrafluoroethylene perfluoro (alkyl vinyl ether) (PFA), fluorinated ethylene propylene (FEP), fluoroelastomer (FKM), ethylene tetrafluoroethylene polymer (ETFE), polyvinylidene fluoride (PVDF), polychlorotrifluoroethylene (CTFE), and polyvinyl fluoride (PVF).

178. The battery of claim 174, wherein said anode electrode composition contains from about 1 to about 10 weight percent fluoropolymer binder and from about 90 to about 99 weight percent anode active particles.
